(19) United States
(12) Patent Application Publication
(10) Pub. No.: US 2025/0381655 A1
(43) Pub. Date: Dec. 18, 2025

(54) SYSTEMS AND METHODS FOR TOOL HOLDERS FOR AN IMPACT TOOL

(71) Applicant: Milwaukee Electric Tool Corporation, Brookfield, WI (US)

(72) Inventors: Tanner J. Vaculik, Brown Deer, WI (US); Troy C. Thorson, Cedarburg, WI (US); Kyle W. Schultz, Mequon, WI (US)

(21) Appl. No.: 19/239,324

(22) Filed: Jun. 16, 2025

Related U.S. Application Data
(60) Provisional application No. 63/660,406, filed on Jun. 14, 2024.
(60) Provisional application No. 63/752,037, filed on Jan. 31, 2025.

(51) Int. Cl. B25D 17/08

(52) U.S. Cl. CPC B25D 17/088; B25D 2217/0042; B25D 2250/095

(57) ABSTRACT

A tool holder for a rotary impact tool can include a plurality of retention members, an anvil movably received in a spindle and configured to impact a bit, the spindle defining a longitudinal axis and including a channel extending along the longitudinal axis, and a plurality of slots that open into the channel and are sized to receive the plurality of retention members, and a chuck collar that is rotatable about the longitudinal axis to selectively place the tool holder in an unlocked configuration and a locked configuration. The chuck collar can include a plurality of sockets sized to receive the plurality of retention members. The plurality of retention members can be recessed in the plurality of sockets in the unlocked configuration and extend through the plurality of slots into the internal volume in the locked configuration.

### CROSS-REFERENCE TO RELATED APPLICATIONS

This application is based on, and claims priority to, and incorporates herein by reference in its entirety, U.S. Provisional Application Ser. No. 63/660,406, filed Jun. 14, 2024, and U.S. Provisional Application Ser. No. 63/752,037, filed Jan. 31, 2025.

### BACKGROUND

A power tool (e.g., a rotary hammer, an air hammer, a drill, etc.) can be used to drill, chisel, or otherwise work a workpiece with a bit. A tool head of the power tool can retain the bit to move relative to the power tool to deliver an impact to the workpiece. The bit can be provided in a variety of shapes and sizes for various applications. In some applications, it may be useful to replace the bit (e.g., based on desired applications or wear of the bit).

### SUMMARY

Some embodiments of the invention provide a tool holder for a rotary impact tool. The tool holder can include a plurality of retention members, an anvil movably received in a spindle and configured to impact a bit, the spindle defining a longitudinal axis and including a channel extending along the longitudinal axis, and a plurality of slots that open into the channel and are sized to receive the plurality of retention members, and a chuck collar that is rotatable about the longitudinal axis to selectively place the tool holder in an unlocked configuration and a locked configuration. The chuck collar can include a plurality of sockets sized to receive the plurality of retention members. The plurality of retention members can be recessed in the plurality of sockets in the unlocked configuration and extend through the plurality of slots into the channel in the locked configuration.

In some examples, the tool holder can further include a retaining ring that is coupled to the spindle to retain the chuck collar on the spindle.

In some examples, the tool holder can further include a resilient member positioned between the retaining ring and the chuck collar.

In some examples, the spindle can include a first spindle that is configured to retain the anvil, and a second spindle that is coupled to and coaxial with the first spindle, the first spindle including a groove that receives the retaining ring.

In some examples, the groove can define an axial length taken along the longitudinal axis, and the retaining ring can define a depth taken along the longitudinal axis, which is smaller than the axial length of the groove.

In some examples, the groove can define a first radius at a bottom of the groove, and the retaining ring can have a circular cross section with a second radius that is greater than the first radius.

In some examples, the first radius can be between about 30% and about 95% of the second radius.

In some examples, the tool holder can further include a sleeve that covers at least a portion of the chuck collar, the sleeve being threadably secured to a housing of the rotary impact tool.

In some examples, the sleeve can be secured to the housing via a fastener.

In some examples, the tool holder can further include a biasing member that engages with the chuck collar to bias the chuck collar to the locked configuration.

In some examples, an area of each of the plurality of slots narrows so that the area is greater along an external surface of the spindle than along an inner surface of the spindle that bounds the channel.

In some examples, the chuck collar can include an inner wall that includes the plurality of sockets, and each of the plurality of sockets can include a ramped surface that extends between a bottom of the socket and the inner wall.

In some examples, the chuck collar can include a ledge that engages with the spindle to limit rotation of the chuck collar.

According to another aspect of the present disclosure, a tool holder for a power tool can include a spindle that defines a channel that is configured to receive a bit along a longitudinal axis of the power tool. The spindle can include a slot that is configured to receive a retention member and a first groove at a distal end of the spindle. The tool holder can include a chuck collar that is co-axially aligned with the spindle. The chuck collar can include a socket that is configured to receive the retention member. The chuck collar can be rotatable relative to the spindle to selectively align the socket with the slot to allow removal of the bit from the channel. The tool holder can include a retaining ring received in the first groove and configured to limit a translation of the chuck collar past the retaining ring in a direction toward the distal end of the spindle.

In some examples, the first groove can include an axial length that is greater than a cross-sectional diameter of the retaining ring.

In some examples, a radius of the first groove can be smaller than a cross-sectional radius of the retaining ring.

In some examples, the tool holder can further include a resilient member between the chuck collar and the retaining ring, a first plate positioned between the resilient member and the retaining ring, the first plate including a second groove that receives the retaining ring, and a second plate positioned between the resilient member and the chuck collar.

According to yet another aspect of the present disclosure, a power tool can include a housing, a motor disposed in the housing, a first spindle coupled to the housing and defining a longitudinal axis, a second spindle coupled to the first spindle with a fastener, the second spindle including a channel surrounded by a peripheral wall and a slot that extends through the peripheral wall, a retention member received in the slot, a chuck collar that is rotatable about the longitudinal axis between an unlocked configuration where a socket defined in an inner surface of the chuck collar is aligned with the slot to receive the retention member, and a locked configuration where the socket is out of alignment with the slot, a reciprocation assembly driven by the motor and including a striker movably received in the first spindle, an anvil movably received in the first spindle, the anvil moving toward the second spindle when the striker contacts the anvil, a retainer positioned in a groove defined in an external surface of the second spindle, and a resilient member positioned between the retainer and the chuck collar.

In some examples, the striker contacting the anvil can cause the anvil to contact the second spindle and move the second spindle along the longitudinal axis from a first position toward a second position relative to the first spindle, the movement of the second spindle limited by the fastener, and a distance between the first position and the second position can be less than a length of the groove taken along the longitudinal axis.

In some examples, the first spindle can move with the second spindle when the second spindle reaches the second position, the first spindle contacting the chuck collar and causing the chuck collar to move toward the resilient member, the resilient member compressing between the chuck collar and the retainer to absorb force imparted to the chuck collar by the first spindle.

This Summary and the Abstract are provided to introduce a selection of concepts in a simplified form that can be further described below in the Detailed Description. This Summary and the Abstract are not intended to identify key features or essential features of the claimed subject matter, nor are they intended to be used as an aid in determining the scope of the claimed subject matter.

### BRIEF DESCRIPTION OF THE DRAWINGS

The accompanying drawings, which are incorporated in and form a part of this specification, illustrate embodiments of the disclosed technology and, together with the description, serve to explain the principles of embodiments of the disclosed technology:

FIG. 1 is an axonometric view of an example impact tool.

FIG. 2 is a side cross-sectional view of the impact tool of FIG. 1 taken along line 2-2 of FIG. 1.

FIG. 3 is a side cross-sectional view of a tool head of another example impact tool.

FIG. 4 is an axonometric view of a tool holder of an impact tool according to aspects of the present disclosure.

FIG. 5 is an axonometric view of the tool holder of FIG. 4 in an unlocked configuration, with a chuck collar rendered transparently.

FIG. 6 is a side cross-sectional partial view of the tool holder of FIG. 5.

FIG. 7 is an axonometric view of the tool holder of FIG. 4 in a locked configuration, with the chuck collar rendered transparently.

FIG. 8 is a side cross-sectional partial view of the tool holder of FIG. 7.

FIG. 9 is an axonometric partial view of a tool holder according to aspects of the present disclosure.

FIG. 10 is a cross-sectional view of the tool holder of FIG. 9.

FIG. 11 is a side cross-sectional view of a tool holder according to aspects of the present disclosure.

FIG. 12 is an axial cross-sectional view of the tool holder of FIG. 11.

FIG. 13 is a side cross-sectional partial view of a tool holder according to aspects of the present disclosure.

FIG. 14 is a side cross-sectional partial view of a tool holder according to aspects of the present disclosure.

FIG. 15 is a side cross-sectional partial view of a tool holder according to aspects of the present disclosure in an unlocked configuration.

FIG. 16 is a side cross-sectional partial view of the tool holder of FIG. 15 in a locked configuration.

FIG. 17 is an axonometric view of a tool holder of an impact tool according to aspects of the present disclosure.

FIG. 18 is an axonometric view of the tool holder of FIG. 17 with a chuck collar and a sleeve removed.

FIG. 19 is an axonometric exploded view of the chuck collar and a plate of the tool holder of FIG. 17.

FIG. 20 is a side cross-sectional view of the tool holder of FIG. 17 in a locked configuration.

FIG. 21 is a side cross-sectional view of the tool holder of FIG. 17 in an unlocked configuration showing a ball detent in a first position.

FIG. 22 is another side cross-sectional view of the tool holder of FIG. 17 in the unlocked configuration showing the ball detent in a second position.

FIG. 23 is a side cross-sectional view of a tool holder according to aspects of the present disclosure.

FIG. 24 is an axonometric view of a chuck collar of the tool holder of FIG. 23.

FIG. 25 is an enlarged view of a portion of the tool holder of FIG. 23 labeled “25-25” in FIG. 23.

### DETAILED DESCRIPTION

The following discussion is presented to enable a person skilled in the art to make and use embodiments of the disclosed technology. Given the benefit of this disclosure, various modifications to the illustrated embodiments will be readily apparent to those skilled in the art, and the principles herein can be applied to other embodiments and applications without departing from embodiments of the disclosed technology. Thus, embodiments of the disclosed technology are not intended to be limited to embodiments shown, but are to be accorded the widest scope consistent with the principles and features disclosed herein.

The following detailed description is to be read with reference to the figures, in which like elements in different figures have like reference numerals. The figures, which are not necessarily to scale, depict selected embodiments and are not intended to limit the scope of embodiments of the disclosed technology. Skilled artisans will recognize the examples provided herein have many useful alternatives and fall within the scope of embodiments of the disclosed technology.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

As generally noted above, a power tool can be provided with a bit (e.g., a drill bit, a chisel bit, etc.) having various shapes and sizes for various applications. The power tool can include a tool holder to secure the bit to a tool head of the power tool or remove the bit from the power tool. For example, the tool head can typically include a plurality of ball bearings that contact the bit at multiple points to tighten the bit in place. Alternatively, the ball bearings can constrict a passageway for the bit to be removed from the tool head. The ball bearings can be moved radially away from the bit (e.g., via a chuck) to permit the bit to be slidably removed from the tool head.

The present disclosure provides a power tool with a tool holder that permits removal or replacement of a bit with greater case as compared to conventional approaches. For example, a tool holder can include a chuck collar that can rotate (e.g., by twisting the chuck collar), or can be pushed or pulled axially, to align ball bearings in a locked configuration or in an unlocked configuration. In some examples, the tool holder can include one or more springs that can engage with one or more corresponding surfaces to bias or otherwise guide a movement of the chuck collar or the ball bearings. In some examples, a tool holder can include a chuck collar that can be pulled away from an operator to replace a bit. In some applications, a tool bit can be replaced without exerting an external force on the chuck collar (e.g., to prevent the chuck from closing in the ball bearings).

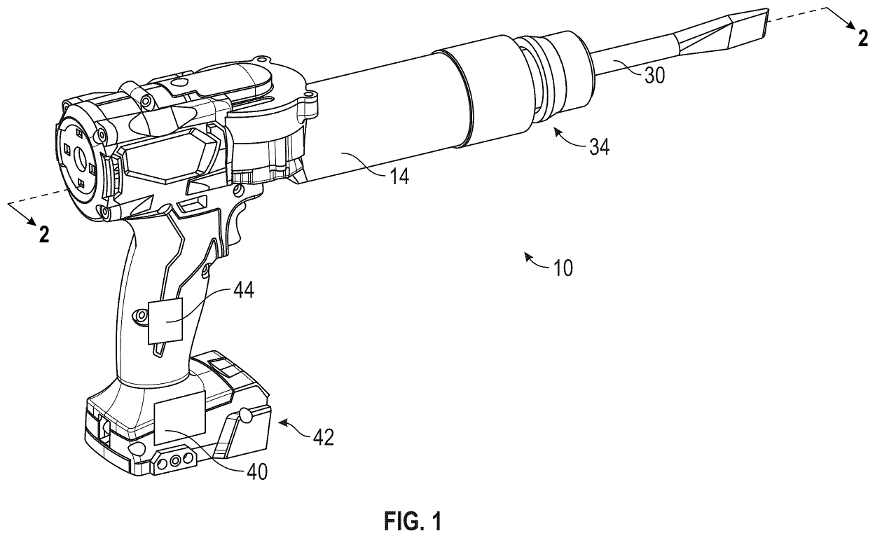

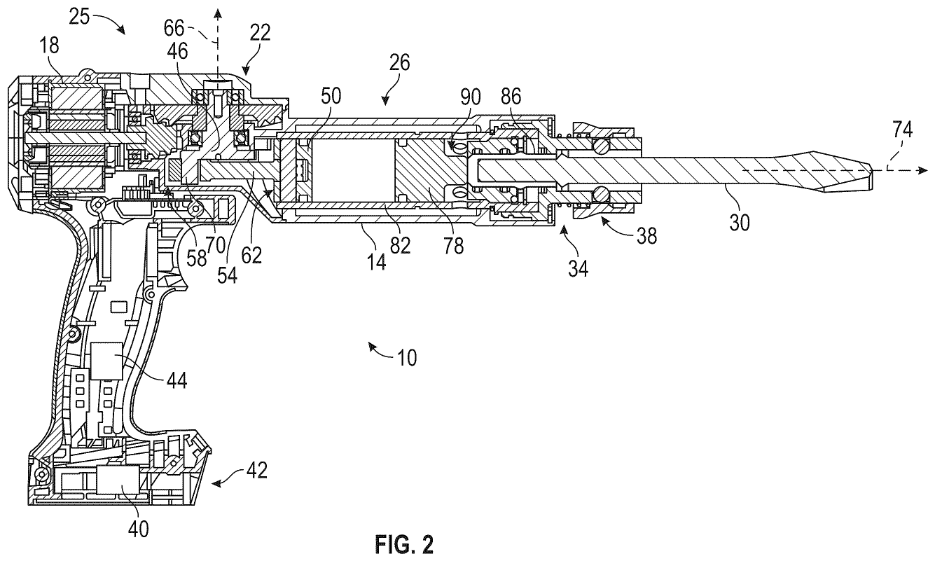

Generally, examples of the disclosed technology can be implemented on any variety of power tools that operate with removable bits. In particular, some examples may be used with impact drivers, including rotary hammers, chisel hammers or other known implementations. In this regard, for example, FIGS. 1-2 illustrate a power tool 10 in the form of a hammer tool (e.g., chisel hammer). The power tool 10 can include a housing 14 and a motor 18 disposed within the housing 14. The power tool 10 can further include a reciprocation drive assembly 22 (shown in FIG. 2) coupled to the motor 18 for converting torque from the motor 18 (e.g., as the motor 18 rotates about a motor axis 24) to reciprocating motion. In some examples, the reciprocation drive assembly 22 can be coupled to the motor 18 via a transmission 25. An impact mechanism 26 can be coupled to the reciprocation drive assembly 22 to impart repeating axial impacts on a tool bit 30 (e.g., a chisel bit or an output tool). As shown in FIG. 1, the tool bit 30 may be slidably supported by a tool holder 34 coupled to the housing 14 so that the tool bit 30 is permitted to translate along its axis to impart the axial impacts to a work piece. In the illustrated construction, the power tool 10 includes a quick-connect mechanism 38 coupled to the tool holder 34 to facilitate quick removal and replacement of different tool bits 30. In other applications, other types of chucks can be used in place of the quick-connect mechanism 38, as may allow for tooled or toolless bit changes.

Referring in particular to FIG. 2, in the illustrated construction of the power tool 10, the motor 18 can be configured as a direct-current (DC) motor 18 that receives power from an on-board power source (e.g., a battery pack 40). The housing 14 can define a battery receptacle 42 that detachably receives the battery pack 40. The battery pack 40 may include any of a number of different nominal voltages (e.g., 12V, 18V, etc.), and may be configured having a Lithium-based chemistry (e.g., Lithium, Lithium-ion, etc.) or any other suitable chemistry. Alternatively, the motor 18 may be powered by a remote power source (e.g., a household electrical outlet) through a power cord. The motor 18 is selectively activated by depressing a trigger which, in turn, activates an internal switch. The switch may be electrically connected to the motor 18 via a top-level or master controller 44 (e.g., a microcontroller), or one or more circuits, for controlling operation of the motor 18.

With continued reference to FIG. 2, the reciprocation drive assembly 22 can be configured to convert rotational motion of the motor 18 (e.g., via the transmission 25) into reciprocating linear motion of a piston. In the illustrated example, the reciprocation drive assembly 22 can be configured as a slider crank mechanism that includes a crankshaft 46, a reciprocating piston 50, and a connecting rod 54. The connecting rod 54 is pivotably coupled to the crankshaft 46 at a first end 58 and pivotably coupled to the piston 50 at a second end 62. The crankshaft 46 can be configured to receive torque from the motor 18 and rotate about a crankshaft axis 66. The crankshaft 46 can include a crank pin 70 that couples to the first end 58 of the connecting rod 54. Correspondingly, as the crankshaft 46 rotates about the crankshaft axis 66, the connecting rod 54 drives the piston 50 to reciprocate along a reciprocation axis 74 and within a spindle 82 (e.g., a barrel) supported within the housing 14. In the illustrated example, the spindle 82 is stationary. However, in other examples, such as rotary hammers, the spindle 82 can be rotated by the motor 18 to cause rotation of a tool bit.

In some embodiments, the reciprocation drive assembly 22 can be realized by other mechanisms, including those known in the art to convert rotational motion to reciprocating motion (e.g., a scotch-yoke mechanism, a wobble drive mechanism, a swash plate mechanism, etc.). In this regard, although the various tool holders discussed below may be utilized in combination with the illustrated reciprocation drive assembly 22, various other implementations are also possible.

A reciprocation assembly moves to generate impact to a tool bit via an impact mechanism. That is, the impact mechanism moves in response to movement of the reciprocation assembly to impact a tool bit. In the illustrated example, the impact mechanism 26 includes a striker 78 and an anvil 86 that are moveably received in the spindle 82. The striker 78 is positioned between the piston 50 and the anvil 86 and selectively reciprocates toward the tool bit 30. The impact between the striker 78 and the anvil 86 can be transferred to the tool bit 30, causing the anvil 86 to reciprocate for performing work on a work piece. Further, in the illustrated construction of the power tool 10, the spindle 82 is hollow and defines an interior chamber 90 (e.g., a bore) in which the striker 78 is received. An air spring 92 (e.g., an air pocket or an air cushion) can be developed between the piston 50 and the striker 78 when the piston 50 reciprocates within the spindle 82, whereby expansion and contraction of the air spring 92 induces reciprocation of the striker 78. That is, as the piston 50 moves towards the striker 78, the volume of the air spring 92 is reduced, which increases pressure within the air spring 92. This increase in pressure can be sufficient to move the striker 78 in the same direction as the piston 50 and cause the striker 78 to impact the anvil 86 to deliver an impact to a workpiece via the tool bit 30. Conversely, as the piston 50 moves away from the striker 78, the volume of the air spring 92 can increase, which reduces pressure within the air spring 92. This reduction in pressure can be sufficient to move the striker 78 in the same direction as piston 50, causing the striker 78 to retract and move away from the anvil 86.

In some cases, the striker 78 or the anvil 86 can form a seal against an interior surface of the spindle 82 via one or more sealing rings. In some examples, maintaining the seal between the striker 78 and the spindle 82 can help to maintain the air spring 92 formed within the interior chamber 90.

In some non-limiting cases, the motor 18 can be positioned within the housing 14 (e.g., within a gearcase disposed within the housing 14), and the spindle 82 can be coupled to the housing 14. In some non-limiting cases, the motor 18 can be positioned within the housing 14, the spindle 82 can be rotatable. For example, the transmission 25 between the motor 18 and the spindle 82 can transmit torque from the motor 18 to the spindle 82, causing the spindle 82 to rotate when the motor 18 is activated. The transmission 25 can include a geartrain, although other types of transmission systems can be used, for example, belt drives, chain drives, etc.

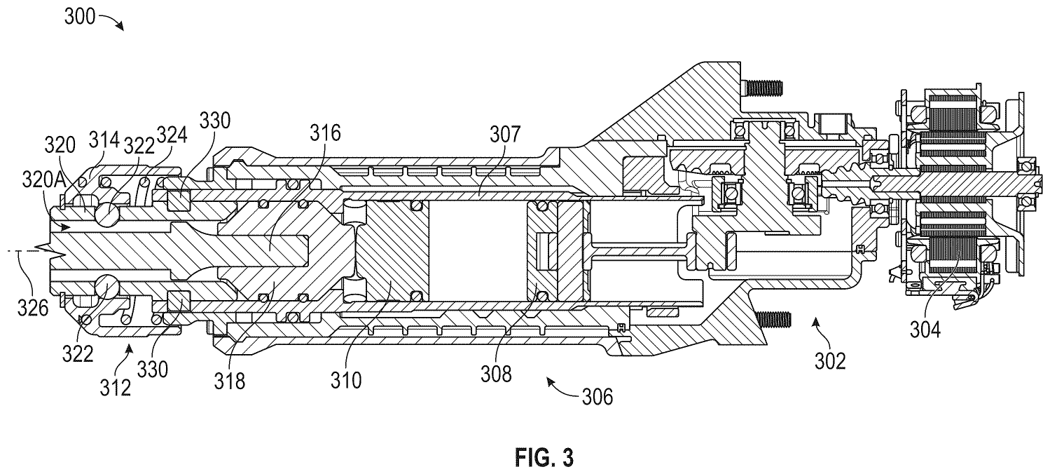

FIG. 3 illustrates an example of a tool head 300 of a power tool (e.g., a rotary hammer, a drill, etc.), which can be implemented as a particular example of a tool head of the power tool 10 of FIGS. 1 and 2. Similar to the tool head of the power tool 10 described above, the tool head 300 can include similar components and functions to the tool head of FIGS. 1 and 2. Thus, like names to designate the same or similar components described above will be used where applicable, and discussion of these components above generally applies relative to the examples below. For example, the tool head 300 has an impact mechanism 306 just as the tool head of FIGS. 1 and 2 has the impact mechanism 26.

In particular, the tool head 300 can include a reciprocation drive assembly 302 that engages with a motor 304 to convert torque from the motor 304 to reciprocating motion. The reciprocation drive assembly 302 engages with an impact mechanism 306 to transfer the reciprocating motion as impact energy for performing work on a work piece. For example, the impact mechanism 306 can include a piston 308 that is secured to the reciprocation drive assembly 302 and a striker 310 that engages with the piston 308. Within a spindle housing 307 (e.g., a rear spindle), the piston 308 can translate linearly along an axis 326 and deliver the impact energy from the reciprocation drive assembly 302 to the striker 310. The striker 310 can move linearly along the axis and transfer the impact energy to a bit 316 which may be secured to a tool holder 312.

The tool holder 312 can include an anvil 318 that is shaped and sized to receive the bit 316. The bit 316 can extend through a guide channel 320A defined by a shaft 320 (e.g., a retainer or a front spindle portion) of the tool holder 312 and move along the axis 326 to be inserted into the tool holder 312 or removed from the tool holder 312. For convenience of discussion, an insertion direction of the bit 316 is generally along a first direction along the axis 326, and a removal direction of the bit 316 is generally along a second direction along the axis 326 that is opposite the first direction. It is appreciated that, the tool holder 312 can be used in a variety of orientations. In the illustrated example, the shaft 320 is coupled to the spindle housing 307 via pins 330 (e.g., fasteners, retention members, pins including various types of materials, different types of fasteners, etc.).

The shaft 320 can include slots that extend into the guide channel 320A along a wall of the shaft 320 and that can receive ball bearings 322 (or other retention members, including pins, blocks, etc.) that move within the slots. For example, in a locked configuration (shown in FIG. 3), the ball bearings 322 can be disposed relatively close to the axis 326 to limit a pathway for the bit 316 to translate linearly out of the tool holder 312, and can thereby retain the bit 316 within the guide channel 320A. In an unlocked configuration, the ball bearings 322 can be moved radially away from the axis 326 to open a pathway for the bit 316 to translate linearly into and out of the tool holder 312.

In particular, the tool holder 312 can include a chuck collar 314 that can be placed over the shaft 320 and engage with the ball bearings 322 in locked and unlocked configurations. For example, a spring 324 is provided between a housing of the power tool and the chuck collar 314 to bias movement of the chuck collar 314. As shown in FIG. 3, the spring 324 is extended, and the ball bearings 322 are within the slots of the shaft 320. Thus, pulling out the bit 316 from the tool holder 312 may be limited by the ball bearings 322, due to a distance between the ball bearings 322 being smaller than a largest width of the bit 316. When the chuck collar 314 is moved and the spring 324 is correspondingly compressed, the ball bearings 322 can be aligned with sockets formed in the chuck collar 314. Thus, the ball bearings 322 can be moved radially outward into the sockets and thereby provide clearance for the bit 316 to move along the axis 326 (e.g., to be removed or re-inserted).

In the present example, the chuck collar 314 can be moved to the in the first direction (i.e., pulled toward an operator). However, biasing the chuck collar 314 in other directions (e.g., an opposite direction, away from the operator) can be possible, with corresponding changes in the direction of movement of the chuck collar 314 between locked and unlocked orientations. Further, while a distal end of the bit 316 is not fully shown in FIG. 3 for clarify of presentation, the bit 316 can have a variety of lengths and shapes at the distal end.

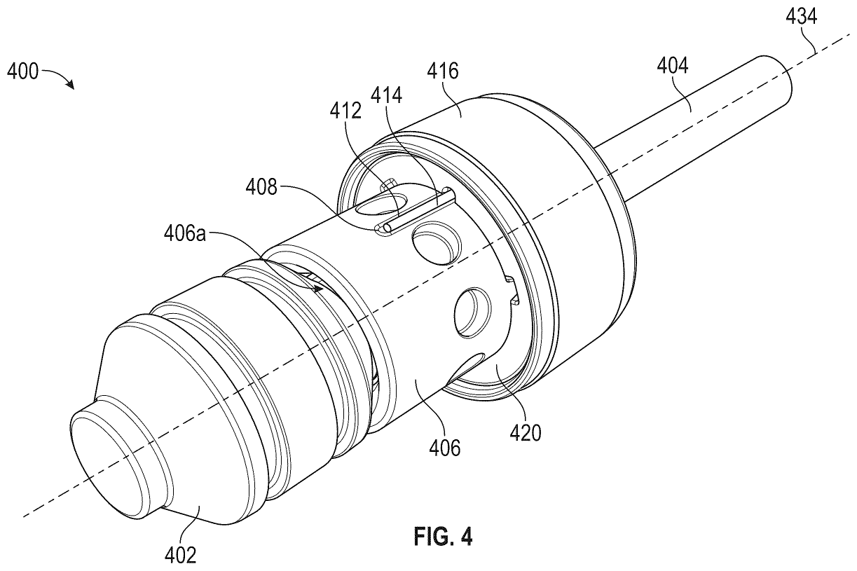

FIGS. 4-8 illustrate an example of a tool holder 400 according to an example of the disclosed technology, which can be implemented in place of the tool holder 312 or on various other impact tools. Generally, the tool holder 400 can include similar components and functions to the tool holder 312. Thus, like names to designate the same or similar components described above will be used where applicable, and discussion of these components above generally applies relative to the examples below. For example, the tool holder 400 has a shaft 406 that defines a guide channel 406A just as the tool holder 312 has the shaft 320 and the guide channel 320A.

In particular, the tool holder 400 includes an anvil 402 that is shaped and sized to receive a bit 404 along an insertion direction along an axis, which extends in a length direction of the bit 404. The bit 404 can extend through the guide channel 406A, coaxially with the anvil 402. Thus, the bit 404 can be removed from the tool holder 400 or inserted into the tool holder 400 along the axis 434.

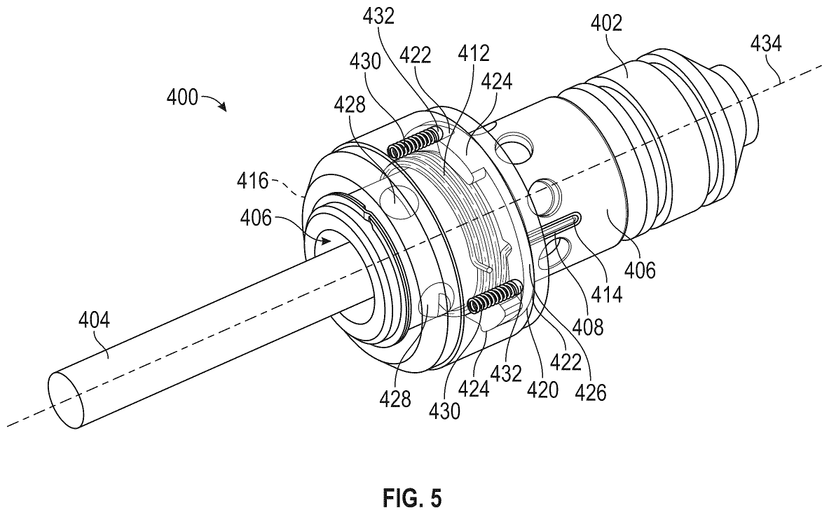

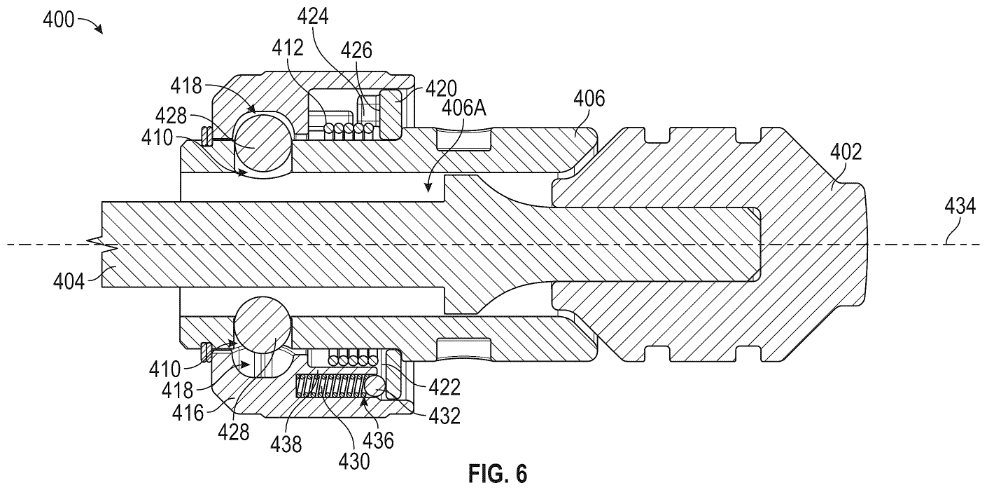

Continuing, the tool holder 400 can include a chuck that includes a chuck collar 416 positioned coaxially with the guide channel 406A (and the shaft 406). As will be discussed in greater detail below, the chuck collar 416 can accommodate a variety of springs and features to help move the tool holder 400 between a locked configuration and an unlocked configuration. For example, the chuck collar 416 can include sockets 418 that are sized and shaped to receive portions of ball bearings 428 (or other retention members) that can be used to control a pathway of the bit 404 along the guide channel 406A. When the ball bearings 428 are recessed into the respective sockets 418 in the unlocked configuration (e.g., illustrated in FIG. 6), the guide channel 406A can have a sufficient clearance for the bit 404 to be removed from the tool holder 400 or inserted into the tool holder 400. In contrast, when the ball bearings 428 are pushed out of the respective sockets 418 in the locked configuration (e.g., illustrated in FIG. 5), portions of the ball bearings 428 may protrude into the guide channel 406A (e.g., in slots 410 of the shaft 406) and block a clear pathway for the bit 404 to be moved linearly out of the tool holder 400.

In the illustrated example, the chuck collar 416 is rotatable about the axis 434 and can receive a spring 412 that biases a rotational movement of the chuck collar 416 about the axis 434. For example, the chuck collar 416 can be twisted in a clockwise direction (e.g., as shown in FIG. 5) to move the tool holder 400 from the unlocked configuration to the locked configuration. As the chuck collar 416 is rotated about the axis 434, the spring 412 can be correspondingly rotated with the chuck collar 416, with an anchor portion 414 of the spring 412 positioned within a slit 408 of the shaft 406 and secured to the shaft 406. Thus, the spring 412 can generally bias the rotational movement of the chuck collar 416 toward a locked configuration.

In some embodiments, the tool holder 400 can include a detent to help secure the chuck collar 416 in a particular orientation (e.g., in the unlocked configuration). For example, the tool holder 400 can include a plate 420, a secondary spring 430, and a ball 432 (or other detent) that engage with one another to further control the rotational movement of the chuck collar 416. In particular, as best illustrated in FIGS. 4 and 6, the plate 420 can be secured to the shaft 406 (e.g., integrally or separately, via keys or other known structures) and include a varied geometry to assist in holding the chuck collar 416 in one or more positions. For example, as shown in FIG. 6, the plate 420 can include a wall 424 that may be taller than a height of the ball 432, a detent recess 422 that may define a first axial offset from the wall 424, and a platform 426 with a second axial offset from the wall 424 that is smaller than the first axial offset. The secondary spring 430 and the ball 432 are retained within the chuck collar 416, such that as the chuck collar 416 rotates about the axis 434, the secondary spring 430 and the ball 432 rotate with the chuck collar 416 and move across surfaces of the plate 420. More specifically, the ball 432 is retained withing a pocket 436 that is defined in the chuck collar 416. The pocket 436 can be formed in a boss 438 (e.g., a protrusion) formed on the chuck collar 416.

In particular, in the unlocked configuration (see, e.g., FIG. 6), the ball 432 is positioned within the detent recess 422, and the secondary spring 430 is in an extended configuration to bias the ball 432 into the detent recess 422. The secondary spring 430 can provide a sufficient amount of spring force to maintain the tool holder 400 in the unlocked configuration against the restoring force corresponding to the rotational bias of the spring 412. The bit 404 may thus be removed (or inserted) without requiring an external force to hold the chuck collar 416 from returning back to the locked configuration.

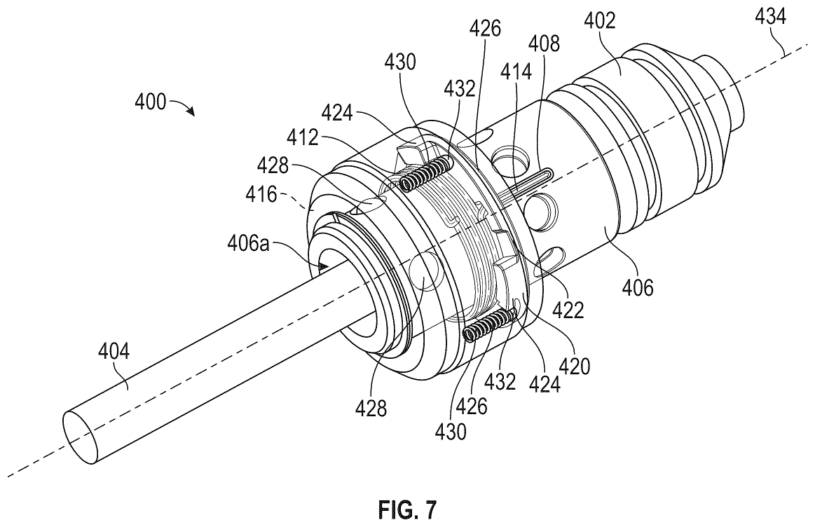

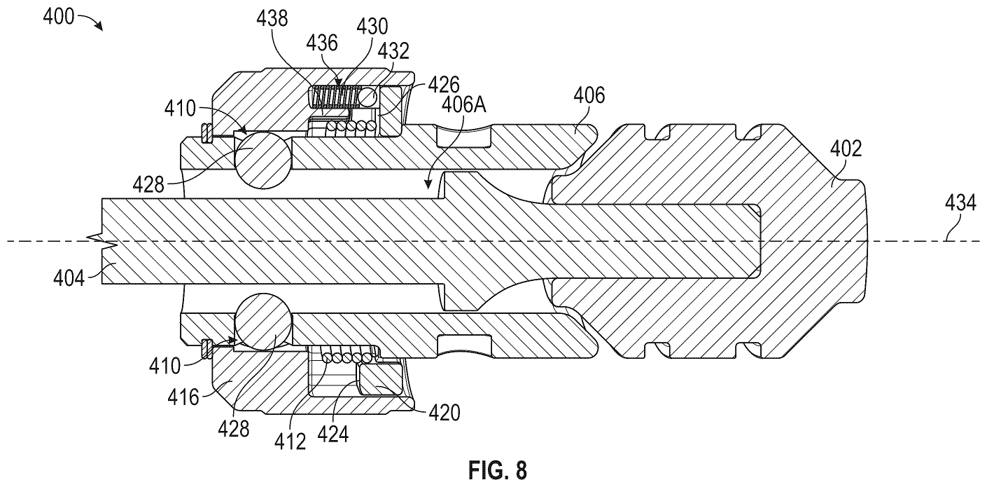

From the unlocked configuration, after application of an external force to the chuck collar 416 to move the ball 432 from the detent recess 422, the chuck collar 416 can rotate under bias of the spring 412 in the clockwise direction to achieve the locked configuration (e.g., as shown in FIGS. 7 and 8). Correspondingly, once released from the detent recess 422, the ball 432 can roll over to a top surface of the platform 426, with the secondary spring 430 being compressed accordingly. With the chuck collar 416 at a locked orientation, the boss 438 may contact the wall 424 and may not be permitted to move past the wall 424. Thus, the rotational movement of the chuck collar 416 may be limited to a prescribed rotation between locked and unlocked orientations (e.g., between two of the walls 424). Further, in some implementations, moving the ball 432 and the secondary spring 430 (e.g., as guided by the boss 438) into the corresponding detent recess 422 may provide sensory feedback (e.g., audibly or tactilely) to signal an operator that the tool holder 400 is in the locked or unlocked configurations.

In the present example, the tool holder 400 can include three sets of the secondary spring 430, the ball 432, the detent recess 422, the platform 426, and the wall 424 to collectively allow the tool holder 400 to be moved between and secure in the locked and unlocked configurations. In some embodiments, more or fewer numbers of the sets can be provided, or other detent mechanisms (or no detent mechanisms) can be used. While the detent recesses 422 are formed on an external piece (e.g., the plate 420) in the present embodiment, detent recesses can be provided in other parts of the tool head, including the shaft 406 or the chuck collar 416 in some embodiments.

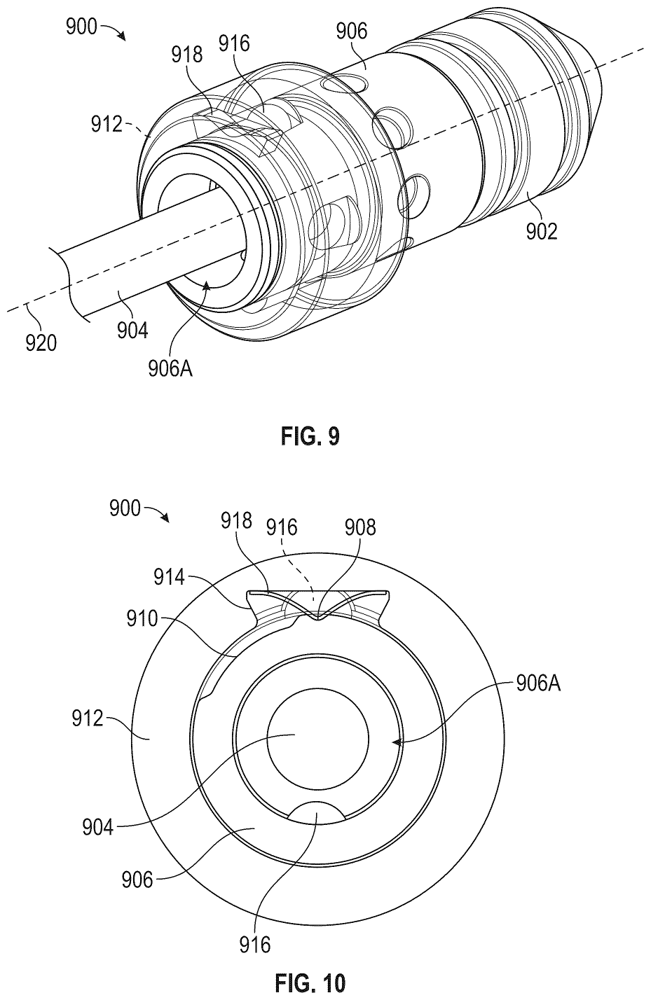

FIGS. 9 and 10 illustrate an example tool holder 900, according to an example of the disclosed technology, which can be implemented in place of the tool holder 312 of FIG. 3, the tool holder 400 of FIGS. 4-8, or on various other impact tools. Generally, the tool holder 900 can include similar components and functions to the tool holder 312. Thus, like names to designate the same or similar components described above will be used where applicable, and discussion of these components above generally applies relative to the examples below. For example, the tool holder 900 has a shaft 906 that defines a guide channel 906A just as the tool holder 312 has the shaft 320 and the guide channel 320A.

The tool holder 900 can include an anvil 902, a shaft 906 defining a guide channel 906A, a chuck collar 912. A bit 904 that extends through the guide channel 906A along an axis 920, to be secured to the anvil 902. The tool holder 900 can include ball bearings 916 that help retaining the bit 904 within the guide channel 906A in a locked configuration, as similarly discussed for other examples above. The chuck collar 912 can be rotated about the axis 920 to move the tool holder 900 between the locked configuration and an unlocked configuration.

In particular, the tool holder 900 can include a leaf spring 918 positioned in a pocket 914 of the chuck collar 912. As the chuck collar 912 rotates, the leaf spring 918 can move between a relatively shallow detent recess 908 and a more deeply recessed portion 910 of the guide channel 906A. In the unlocked configuration (e.g., shown in FIG. 10), the ball bearings 916 are recessed into respective ball bearing sockets in the chuck collar 912. The leaf spring 918, as compressed by engagement with the detent recess 908, can hold the chuck collar 912 in the unlocked configuration. Accordingly, the bit 904 can be removed from the tool holder 900 without having to hold the other components (e.g., the chuck collar 912) concurrently.

In some non-limiting embodiments, the leaf spring 918 may be housed in different parts of the tool holder 900 and engage with detents formed on different parts of the tool holder 900. For example, a pocket may be provided on the shaft 906 and house the leaf spring 918. A detent recess can be provided on the chuck collar 912 and engage with the leaf spring 918.

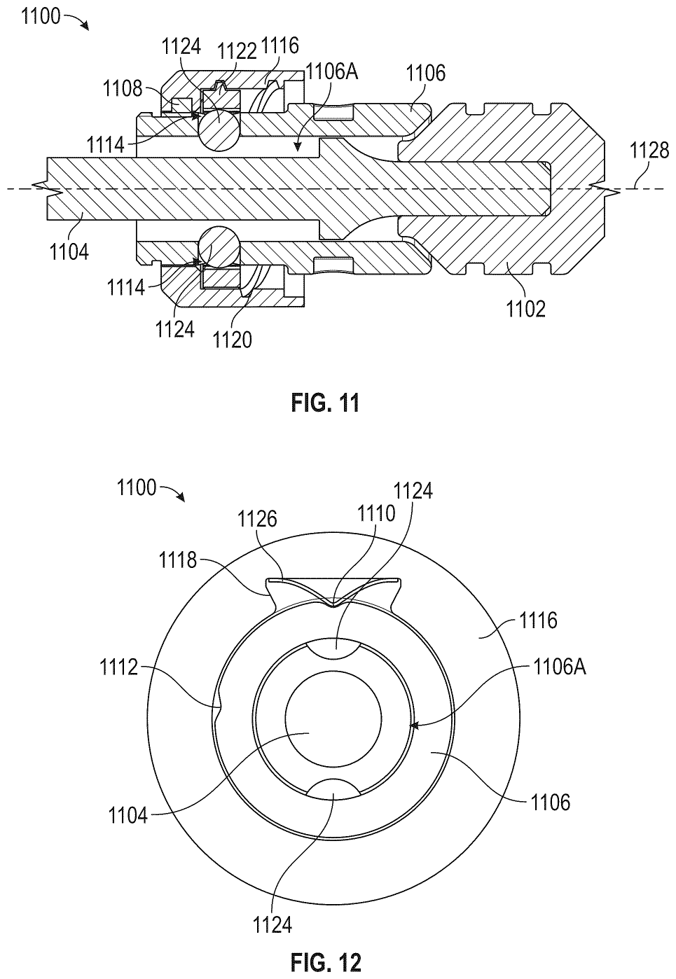

FIGS. 11 and 12 illustrate an example tool holder 1100, according to an example of the disclosed technology, which can be implemented in place of the tool holder 312 of FIG. 3, the tool holder 400 of FIGS. 4-8, the tool holder 900 of FIGS. 9 and 10, or on various other impact tools. Generally, the tool holder 1100 can include similar components and functions to the tool holder 312. Thus, like names to designate the same or similar components described above will be used where applicable, and discussion of these components above generally applies relative to the examples below. For example, the tool holder 1100 has a shaft 1106 that defines a guide channel 1106A just as the tool holder 312 has the shaft 320 and the guide channel 320A.

The tool holder 1100 can include an anvil 1102, a shaft 1106 with a guide channel 1106A, and a chuck collar 1116. A bit 1104 can extend through the guide channel 1106A along an axis 1128 to be secured to the anvil 1102. The tool holder 1100 can include ball bearings 1124 that help retaining the bit 1104 within the guide channel 1106A in a locked configuration, as similarly discussed for other examples above. The chuck collar 1116 can be rotated about the axis 1128 to move the tool holder 1100 between the locked configuration and an unlocked configuration. For example, a protrusion 1108 from the that engages with the chuck collar 1116 (e.g., to guide rotational movement of the chuck collar 1116 relative to the guide channel 1106A).

In particular, the tool holder 1100 can include a threaded ring 1122 positioned between the guide channel 1106A and the chuck collar 1116. The chuck collar 1116 can include internal threads 1120 that generally correspond to the external threads of the threaded ring 1122. Thus, as the chuck collar 1116 rotates about the axis 1128, the threaded ring 1122 can be translated axially relative to the chuck collar 1116 along the shaft 1106 (via the internal threads 1120). For example, in the locked configuration (e.g., shown in FIG. 11), the threaded ring 1122 is positioned above slots 1114 of the guide channel 1106A, and the ball bearings 1124 can thus be held radially inward to limit a pathway for the bit 1104 within the guide channel 1106A. In the unlocked configuration, the threaded ring 1122 can move away from the slots 1114, and the ball bearings 1124 can move radially outward to be recessed into the chuck collar 1116.

Further, as shown in FIG. 12, the tool holder 1100 can include a leaf spring 1126 that engages with an outer surface of the guide channel 1106A as the chuck collar 1116 is rotated. For example, the leaf spring 1126 can be received within a pocket 1118 of the chuck collar 1116. The outer surface of the guide channel 1106A can include a first detent recess 1110 and a second detent recess 1112. Accordingly, the leaf spring 1126 can move from the first detent recess 1110 to the second detent recess 1112, as the chuck collar 1116 rotates counterclockwise, to selectively hold the chuck collar 1116 in the corresponding orientation. Thus, for example, engagement of the leaf spring 1126 with the second detent 1112 can permit the chuck collar 1116 to remain in position while the bit 1104 is being removed or inserted along the axis 1128.

Advantageously, the tool holder 1100 can provide a greater customizability and flexibility than some designs. For example, it may be possible to rotate of the chuck collar 1116 for more than 60 degrees (e.g., given a 360-degree range of the internal threads 1120). In some embodiments, the tool holder 1100 can include a torsion spring to bias the rotational movement in a particular direction (e.g., toward the unlocked configuration).

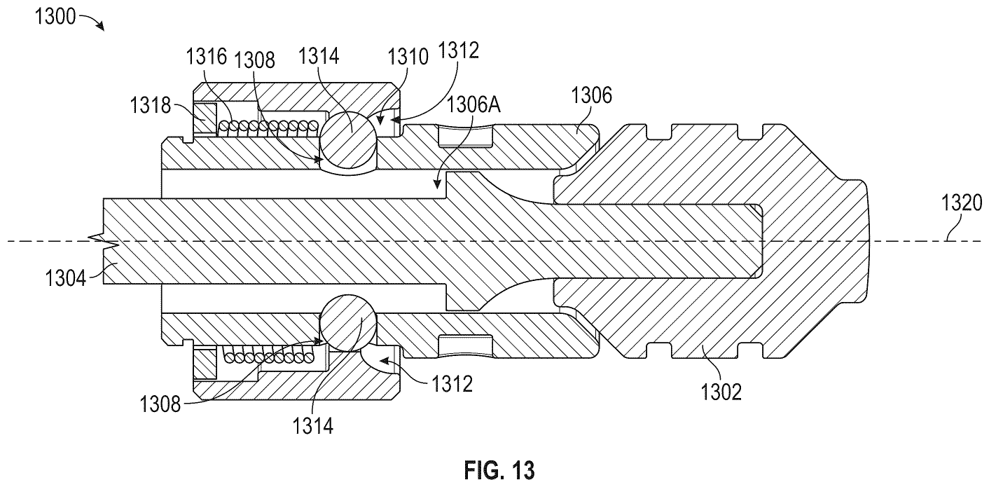

FIG. 13 illustrates an example tool holder 1300, according to an example of the disclosed technology, which can be implemented in place of the tool holder 312 of FIG. 3, the tool holder 400 of FIGS. 4-8, the tool holder 900 of FIGS. 9 and 10, the tool holder 1100 of FIG. 11, or on various other impact tools. Generally, the tool holder 1100 can include similar components and functions to the tool holder 312. Thus, like names to designate the same or similar components described above will be used where applicable, and discussion of these components above generally applies relative to the examples below. For example, the tool holder 1300 has a shaft 1306 that defines a guide channel 1306A just as the tool holder 312 has the shaft 320 and the guide channel 320A.

The tool holder 1300 can include an anvil 1302, a shaft 1306 that defines a guide channel 1306A, and a chuck collar 1310. A bit 1304 can extend through the guide channel 1306A along an axis 1320 to be secured to the anvil 1302. The tool holder 1300 can include ball bearings 1314 that are positioned in slots 1308 of the guide channel 1306A and help retain the bit 1304 within the guide channel 1306A in a locked configuration, as similarly discussed above. The tool holder 1300 can further include a base 1318 (e.g., a base plate) positioned at an end of the chuck collar 1310 and linear springs 1316 positioned between ball bearings 1314 and the base 1318.

To move the tool holder 1300 from the locked configuration to an unlocked configuration (e.g., as shown in FIG. 13), the chuck collar 1310 can be moved (e.g., pulled) toward the base 1318 along the axis 1320 (e.g., in the second direction). The base 1318 may not move relative to the guide channel 1306A. Pulling the chuck collar 1310 in the second direction can compress the linear springs 1316 and allow the ball bearings 1314 to move into respective sockets 1312 of the chuck collar 1310. Correspondingly, the bit 1304 can be removed from the tool holder 1300 along the axis 1320. The bit 1304 can be re-inserted into the tool holder 1300 with the chuck collar 1310 pulled and the linear springs 1316 can move the chuck collar 1310 to return to the locked configuration. Advantageously, the tool holder 1300 can tend to remain in the locked configuration even if the chuck collar 1310 is pressed into a work (or other) surface, while still allowing the bit 1304 to be removed easily by simply pulling the chuck collar 1310 away from the operator.

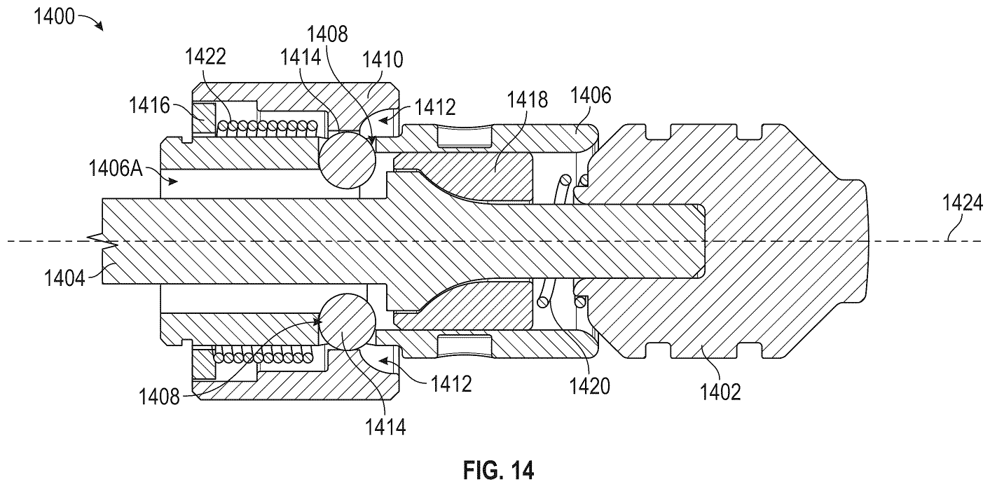

FIG. 14 illustrates an example tool holder 1400, according to an example of the disclosed technology, which can be implemented in place of the tool holder 312 of FIG. 3, the tool holder 400 of FIGS. 4-8, the tool holder 900 of FIGS. 9 and 10, the tool holder 1100 of FIG. 11, the tool holder 1300 of FIG. 13, or on various other impact tools. Generally, the tool holder 1400 can include similar components and functions to the tool holder 312. Thus, like names to designate the same or similar components described above will be used where applicable, and discussion of these components above generally applies relative to the examples below. For example, the tool holder 1400 has a shaft 1406 that defines a guide channel 1406A just as the tool holder 312 has the shaft 320 and the guide channel 320A.

The tool holder 1400 can include an anvil 1402, a shaft 1406 that defines a guide channel 1406A, and a chuck collar 1410. A bit 1404 can extend through the guide channel 1406A along an axis 1424 and is secured to the anvil 1402. The tool holder 1400 can include ball bearings 1414 that are positioned in slots 1408 of the guide channel 1406A and retain the bit 1404 within the guide channel 1406A in a locked configuration (e.g., as shown in FIG. 14), as similarly discussed above. Further, the tool holder 1400 can include a sleeve 1418 that is defined by an internal shape that corresponds to an outer shape of the bit 1404. A spring 1420 can be provided between the sleeve 1418 and the anvil 1302 to bias a linear movement of the sleeve 1418 and the bit 1404 along the axis 1424, toward the entrance to the guide channel 1406A.

Continuing, the tool holder 1400 can include a base 1416 positioned at an end of the chuck collar 1410 and secondary spring 1422 positioned between ball bearings 1414 and the base 1416. Thus, the chuck collar 1410 can be pulled toward the base 1416 along the axis 1424, and the ball bearings 1414 can correspondingly be received into respective sockets 1412 of the chuck collar 1410 to achieve an unlocked configuration of the tool holder 1400. Further, the spring 1420 can expand over a distance sufficient to push the sleeve 1418 into alignment with the slots 1408 and thereby retain the ball bearings 1414 radially outside of the sleeve 1418. Correspondingly, as the bit 1404 is removed from the tool holder 1400, the ball bearings 1414 can remain out of the way of the bit 1404 within the guide channel 1406A. Thus, the bit 1404 can be removed without an external force on the chuck collar 1410. The ball bearings 1414 can be maintained out of the way of insertion of the bit 1404 back into the guide channel 1406A and the anvil 1402. When the bit 1404 is inserted into the tool holder 1400 along the axis 1424, the sleeve 1418 can be correspondingly moved by the bit 1404 to travel along the axis 1424 with the bit 1404, and to thereby permit the ball bearings 1414 to move toward the axis 1424. Thus, the tool holder 1400 may be returned to the locked configuration simply via insertion of the bit 1404.

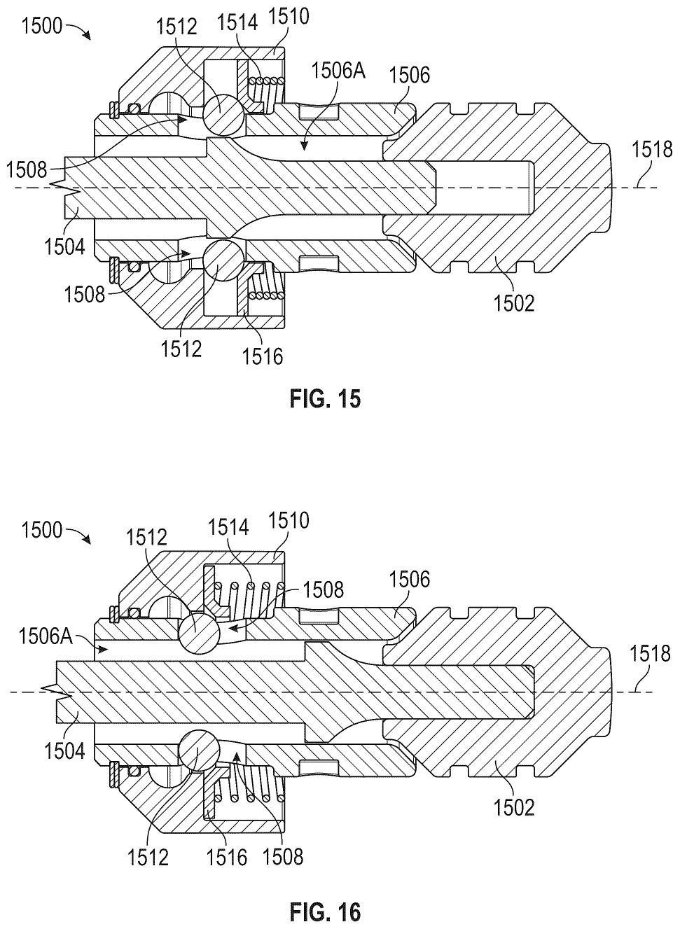

FIGS. 15 and 16 illustrate an example tool holder 1500, according to an example of the disclosed technology, which can be implemented in place of the tool holder 312 of FIG. 3, the tool holder 400 of FIGS. 4-8, the tool holder 900 of FIGS. 9 and 10, the tool holder 1100 of FIG. 11, the tool holder 1300 of FIG. 13, the tool holder 1400 of FIG. 14, or on various other impact tools. Generally, the tool holder 1400 can include similar components and functions to the tool holder 312. Thus, like names to designate the same or similar components described above will be used where applicable, and discussion of these components above generally applies relative to the examples below. For example, the tool holder 1500 has a shaft 1506 that defines a guide channel 1506A just as the tool holder 312 has the shaft 320 and the guide channel 320A.

The tool holder 1500 can include an anvil 1502, a shaft 1506 that defines a guide channel 1506A, and a chuck collar 1510. A bit 1504 can extend through the guide channel 1506A along an axis 1518 and is secured to the anvil 1502. The tool holder 1500 can include ball bearings 1512 that are positioned within elongate slots 1508 of the guide channel 1506A and retain the bit 1504 within the guide channel 1506A in a locked configuration (e.g., as shown in FIG. 16).

Further, the tool holder 1500 can include a spring 1514 that engages with a guide plate 1516 within the chuck collar 1510 to bias the guide plate 1516 toward the entrance into the guide channel 1506A. Correspondingly, in the locked configuration, the guide plate 1516 can bias the ball bearings 1512 forward within the elongate slots 1508 so that the chuck collar 1510 blocks radially outward movement of the ball bearings 1512 and the bit 1504 is retained within the guide channel 1506A. In contrast, as the bit 1504 is inserted into the tool holder 1500, the bit 1504 (e.g., along curved surfaces, as shown) can urge the ball bearings 1512 radially outward and axially in the direction of insertion (and correspondingly along the elongate slots 1508), to overcome the biasing force of the linear spring. Thus, the guide plate 1516 can be moved clear of the ball bearings 1512 and the bit 1504 can slide pass the ball bearings 1512 to an installed configuration. To remove the bit 1504 from the tool holder 1500, the chuck collar 1510 can be pulled toward an operator, thereby aligning recesses in the chuck collar 1510 with the slots 1508 so that the ball bearings 1512 can move radially outwardly to provide clearance for the bit 1504. In some examples, the tool holder 1500 can include an O-ring or other feature to create friction between the chuck collar 1510 and the guide channel 1506A (e.g., to prevent the chuck collar 1510 from moving with the guide plate 1516).

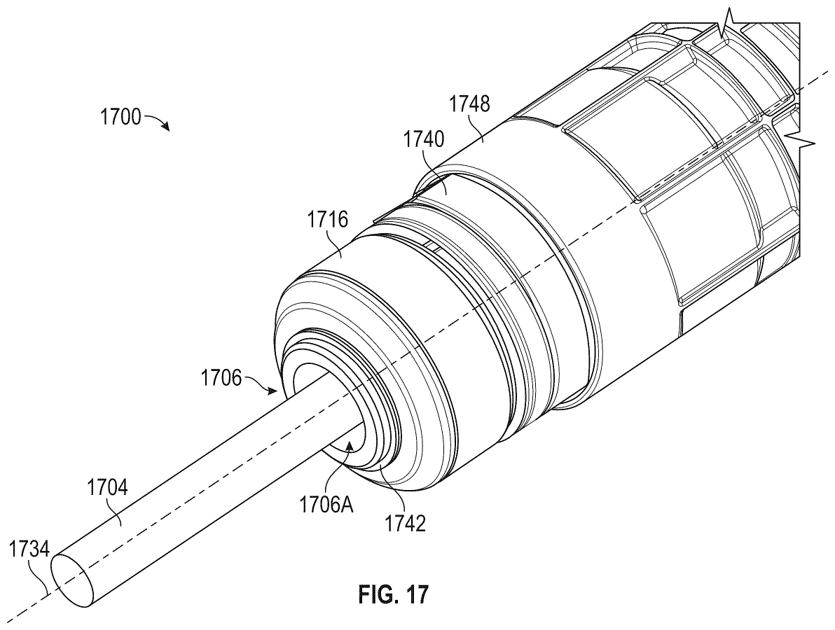

FIGS. 17-22 illustrate another example tool holder 1700, according to aspects of the disclosure, which can be implemented with, for example, the power tool 10 or on various other impact tools. Generally, the tool holder 1700 can include similar components and functions to the tool holder 400. Thus, like names to designate the same or similar components described above will be used where applicable, and discussion of these components above generally applies relative to the examples below. For example, the tool holder 1700 has a spindle 1706 (e.g., a shaft or a barrel) that defines a guide channel 1706A, just as the tool holder 400 has the shaft 406 and the guide channel 406A. Further, the tool holder 1700 includes a chuck collar 1716 and a plate 1720, just as the tool holder 400 includes the chuck collar 416 and the plate 420.

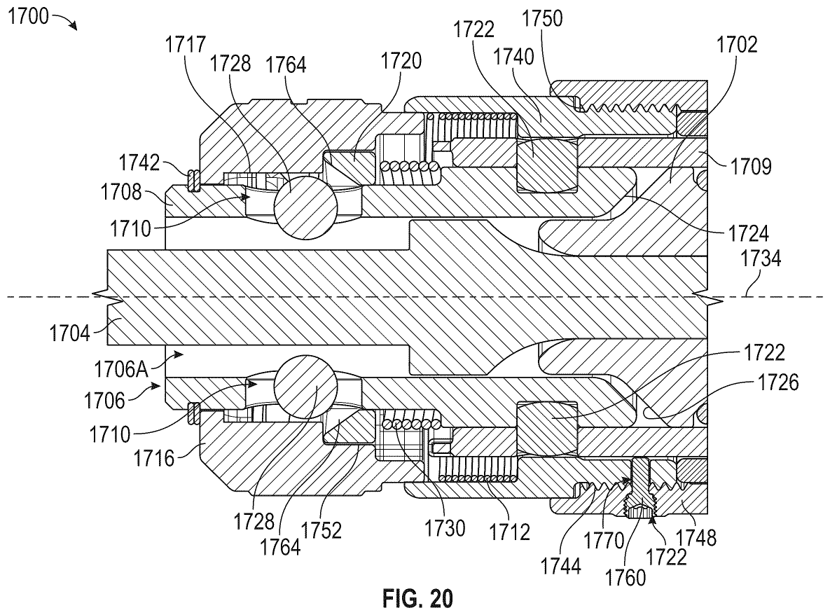

Further, with specific reference to FIGS. 20-22, the power tool for the tool holder 1700 includes retainment features that guide an axial movement of an anvil 1702 along an axis 1734 (e.g., a reciprocation axis). For example, the spindle 1706 includes a retainer 1708 (e.g., a front spindle) and a rear spindle 1709. The retainer 1708 is provided at a distal end of the rear spindle 1709. The retainer 1708 defines the guide channel 1706A (e.g., a bore) that receives a bit 1704 (e.g., a tool bit), and the rear spindle 1709 houses a substantial portion of the anvil 1702. In the illustrated example, the retainer 1708 is coupled to the rear spindle 1709 via pins 1722 (e.g., fasteners, retention members, etc.). The retainer 1708 defines a retainer impact surface 1724 (e.g., a first impact surface) that is configured to engage with a corresponding surface of the anvil 1702. In particular, the anvil 1702 defines a front anvil impact surface 1726 (e.g., a second impact surface) that generally faces toward a front of the tool holder 1700. When the anvil 1702 moves toward the front of the tool holder 1700 along the axis 1734, the retainer impact surface 1724 can engage with the front anvil impact surface 1726 and stop a further movement of the anvil 1702 toward the front of the tool holder 1700.

In some configurations, the retainer 1708 or the rear spindle 1709 can absorb an impact force exerted by a striker of the power tool to the anvil 1702 along the axis 1734 when the anvil 1702 contacts the retainer 1708 or the rear spindle 1709 directly or indirectly (e.g., via the pins 1722). For example, repeated impacts by the striker to the anvil 1702 can cause the retainer 1708 to move toward the front of the tool holder 1700. A ring 1742 (e.g., a C-ring, an O-ring, a washer, etc.) that is secured to a distal end of the retainer 1708 can maintain the position of the retainer 1708 relative to other components of the tool holder 1700, including the chuck collar 1716 or the rear spindle 1709. In some examples, the repeated impacts by the striker to the anvil 1702 can cause the rear spindle 1709 to move toward the front of the tool holder 1700 or contact a rear end of the chuck collar 1716. The movement of the chuck collar 1716 can be retained by the ring 1742 that is secured to the retainer 1708.

In the illustrated example, a profile of the front anvil impact surface 1726 generally corresponds to a profile of the retainer impact surface 1724. For example, each of the front anvil impact surface 1726 and the retainer impact surface 1724 can be frustoconical in shape. In other embodiments, the profiles of the front anvil impact surface 1726 and the retainer impact surface 1724 can be different or include different shapes (e.g., pyramidal, cylindrical, spherical, cubical, cuboidal, conical, etc.). Further, the description of the configurations of the retainer 1708 and the rear spindle 1709 can be applied to any one of the tool holders discussed above with respect to FIGS. 3-16.

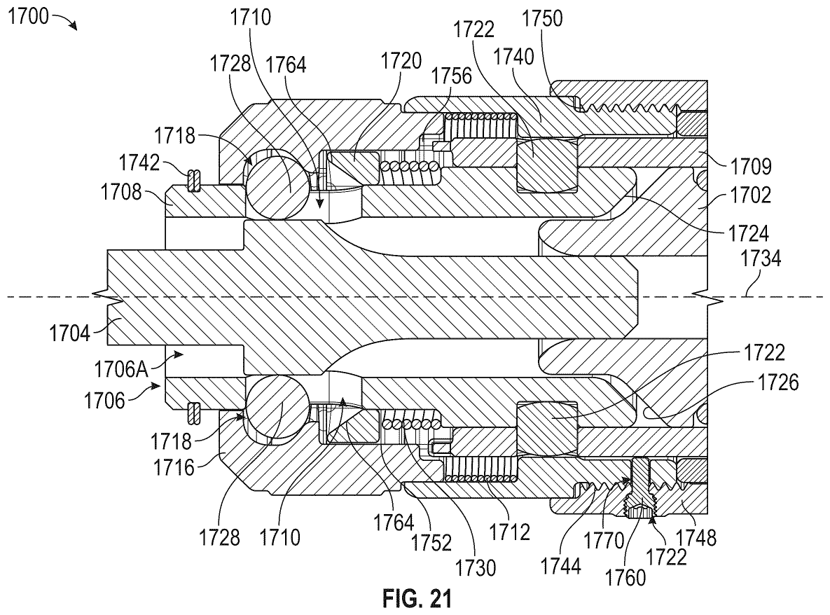

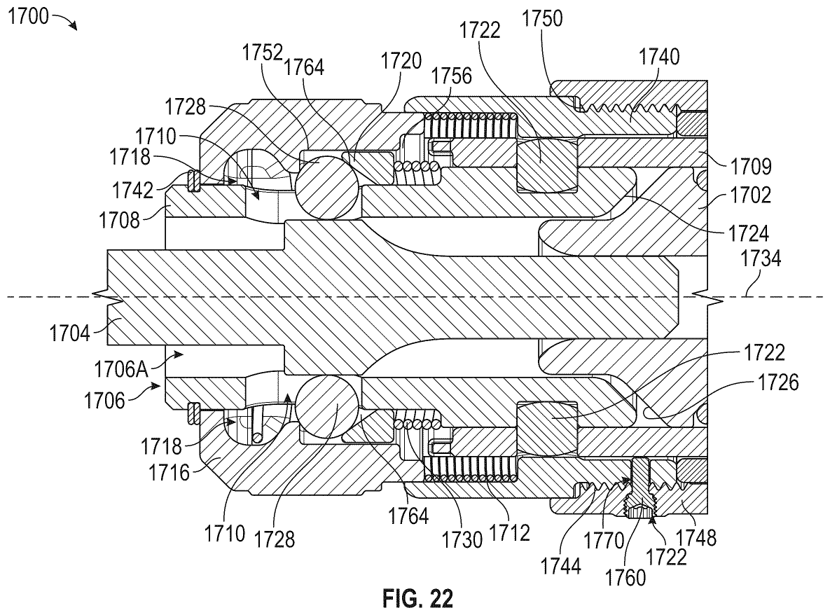

However, the tool holder 1700 differs from the tool holder 400 in some aspects, including configurations of the chuck collar 1716 in a locked configuration (e.g., as shown in FIG. 20) and an unlocked configuration (e.g., as shown in FIGS. 21 and 22). For example, the chuck collar 1716 can remain in the unlocked configuration when the bit 1704 is removed from the tool holder 1700. When the bit 1704 is inserted into the tool holder 1700, the chuck collar 1716 can return to the locked configuration (e.g., without manually operating, for example, by twisting, the chuck collar 1716).

In particular, when the chuck collar 1716 is in the unlocked configuration, the spindle 1706 receives the bit 1704 along an insertion direction along the axis 1734, which extends in a length direction of the spindle 1706. The bit 1704 can extend through the guide channel 1706A (e.g., inner volume of the spindle 1706) so that the bit 1704 can be removed from the tool holder 1700 or inserted into the tool holder 1700 along the axis 1734.

Returning R to FIG. 17, the chuck collar 1716 is positioned coaxially with the spindle 1706. The chuck collar 1716 can engage with a variety of springs and features to help guide and selectively retain the chuck collar 1716 between the locked configuration and the unlocked configuration. In particular, starting from the unlocked configuration, the chuck collar 1716 can rotate or translate in a first direction relative to the spindle 1706 to achieve the locked configuration and help to secure the bit 1704 within the guide channel 1706A. From the locked configuration, the chuck collar 1716 can rotate or translate in a second direction relative to the spindle 1706 to return to the unlocked configuration to release the bit 1704 from the guide channel 1706A. In the unlocked configuration, the chuck collar 1716 can axially translate relative to the spindle 1706 along the axis 1734. The chuck collar 1716 moves relative to the ring 1742, which is secured to the spindle 1706, and a sleeve 1740 (e.g., a front cap of a gearcase) of the tool holder 1700. In particular, the sleeve 1740 axially covers at least a portion of the chuck collar 1716. At least a portion of the chuck collar 1716 translates into and out of the sleeve 1740. Movement of the chuck collar 1716 along the axis 1734 is limited by the sleeve 1740 and the ring 1742.

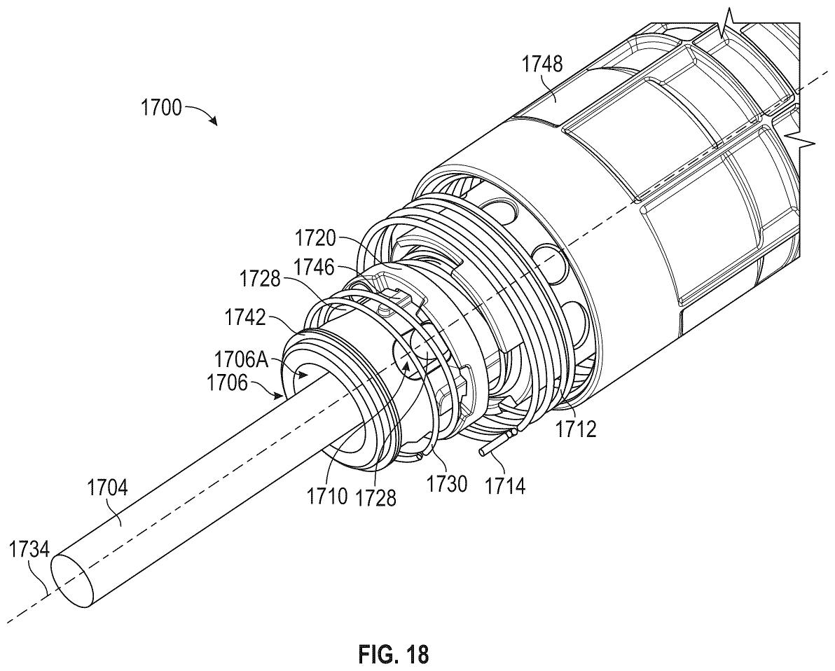

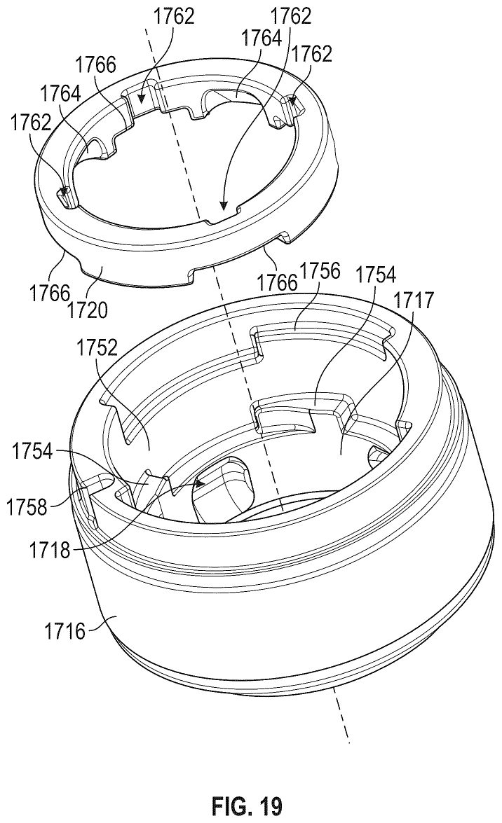

Referring to FIGS. 18 and 19, the chuck collar 1716 is rotatable about the axis 1734 and can engage a spring 1712 (e.g., a torsion spring) that biases a rotational movement of the chuck collar 1716 about the axis 1734 to a first rotational position (e.g., the locked configuration). In particular, the spring 1712 includes an anchor 1714 (e.g., illustrated in FIG. 18) positioned within a slit 1758 of the chuck collar 1716 (e.g., illustrated in FIG. 19) and secured to the chuck collar 1716. The spring 1712 is further secured to the sleeve 1740 so that the spring 1712 is located between the sleeve 1740 and the chuck collar 1716. To achieve the locked configuration as shown in FIG. 20, the chuck collar 1716 can be twisted in a clockwise direction (e.g., as shown in FIG. 18) to move the chuck collar 1716 to a second rotational position (e.g., the unlocked configuration). As the chuck collar 1716 is rotated about the axis 1734 to the second rotational position, the spring 1712 can be correspondingly wound more tightly to store spring energy. In some cases, the spring 1712 can bias the rotational movement of the chuck collar 1716 (e.g., relative to the spindle 1706 or the sleeve 1740) toward the locked configuration.

Further, the chuck collar 1716 includes a variety of geometries that are sized and shaped to engage with ball bearings 1728 (or other retention members) that can be used to control opening and closing (e.g., blocking and unblocking) of a pathway of the bit 1704 along the guide channel 1706A. For example, as best shown in FIG. 19, the chuck collar 1716 includes an inner wall 1717 that includes sockets 1718 that are circumferentially spaced apart. The sockets 1718 are sized and shaped to receive the ball bearings 1728. The chuck collar 1716 further includes an intermediate wall 1752 that defines an inner diameter that is smaller than an inner diameter of the inner wall 1717. The intermediate wall 1752 includes ledges 1756 (e.g., a raised platform) extending axially from the intermediate wall 1752. When the chuck collar 1716 is rotated to achieve the locked configuration, the ledges 1756 can engage with the spindle 1706 and prevent over-rotation of the chuck collar 1716. Further, the intermediate wall 1752 includes guide ramps 1754 that are formed as ramped surfaces to extend between the intermediate wall 1752 and the inner wall 1717. As will be discussed further below, the guide ramps 1754 can guide the movement of the plate 1720 between the unlocked configuration and the locked configuration. In some cases, the guide ramps 1754 can guide the movement of the ball bearings 1728 when the chuck collar 1716 moves between the unlocked configuration and the locked configuration (e.g., such that the ball bearings 1728 do not get stuck between the chuck collar 1716 and the plate 1720).

In the illustrated example, the sleeve 1740 is sized and shaped to engage (e.g., via threads) with a housing 1748 (e.g., a gearcase) of an impact tool that includes the tool holder 1700. With specific reference to FIGS. 20-22, the sleeve 1740 includes a first threaded portion 1744, and the housing 1748 includes a second threaded portion 1750 that includes a profile that corresponds to a profile of the first threaded portion 1744. The first threaded portion 1744 is an externally threaded portion, and the second threaded portion 1750 is an internally threaded portion. Further, the sleeve 1740 is secured to the housing 1748 via a fastener 1760 (e.g., a screw). In particular, the sleeve 1740 includes a first hole 1770, and the housing 1748 includes a second hole 1772. When the spindle 1706 is loaded into the housing 1748 from an open end of the tool holder 1700 as shown in FIGS. 20-22, the sleeve 1740 can be threaded into the housing 1748, and the fastener 1760 can be inserted through the first hole 1770 and the second hole 1772 that are aligned with each other. Correspondingly, the fastener 1760 can secure the sleeve 1740 in position relative to the housing 1748 (e.g., while preventing the sleeve 1740 from backing out of the housing 1748).

Continuing, FIGS. 20-22 illustrate the position of the ball bearings 1728 relative to the chuck collar 1716 in different configurations of the chuck collar 1716. When the ball bearings 1728 are recessed into the respective sockets 1718 in the unlocked configuration (e.g., illustrated in FIG. 21) or pushed along the intermediate wall 1752 in another unlocked configuration (e.g., illustrated in FIG. 22), the guide channel 1706A can have a sufficient clearance for the bit 1704 to be removed from or inserted into the tool holder 1700. In contrast, when the ball bearings 1728 are pushed out of the respective sockets 1718 along the inner wall 1717 in the locked configuration (e.g., illustrated in FIG. 20), portions of the ball bearings 1728 may protrude into the guide channel 1706A (e.g., in slots 1710 of the spindle 1706) and block a clear pathway for the bit 1704 to be moved linearly out of the tool holder 1700. Put differently, the chuck collar 1716 can block radial movement of the ball bearings 1728 to retain the bit 1704 within the chuck collar 1716 or the guide channel 1706A.

Further, the tool holder 1700 can include a detent mechanism that assists in holding the chuck collar 1716 in a particular orientation. For example, the tool holder 1700 includes the plate 1720 (e.g., a lock plate) and a secondary spring 1730 that biases an axial movement of the plate 1720 toward the ball bearings 1728 along the axis 1734 (e.g., during removal or insertion of the bit 1704). Further, the plate 1720 is secured to the spindle 1706 and located radially within the chuck collar 1716. The plate 1720 includes channels 1762 (e.g., illustrated in FIG. 19) that engage with keys 1746 extending from outer surface of the spindle 1706 (e.g., illustrated in FIG. 18). Accordingly, when moving between the locked and unlocked configurations, the chuck collar 1716 can rotate relative to the plate 1720 and the spindle 1706. The plate 1720 is fixed against rotation relative to the spindle 1706 due to the keyed engagement between the plate 1720 and the spindle 1706.

Further, the plate 1720 includes a varied geometry that engages with various components of the chuck collar 1716 in the locked and unlocked configurations. For example, as best illustrated in FIG. 19, the plate 1720 includes bevels 1764 between the adjacent channels 1762. In particular, the bevels 1764 can extend at an oblique angle relative to the axis 1734 (e.g., toward the ball bearings 1728). As shown in FIGS. 20-22, The secondary spring 1730 is retained between the spindle 1706 and the chuck collar 1716. In some cases, the ball bearings 1728 can roll toward the intermediate wall 1752 between the plate 1720 and the chuck collar 1716. This allows the ball bearings 1728 to move out of the guide channel 1706A and provide a pathway for the bit 1704 to translate within the guide channel 1706A when the chuck collar 1716 is in the unlocked configuration. Further, the plate 1720 includes notches 1766 that engage with the guide ramps 1754 of the chuck collar 1716. In particular, the notches 1766 are sized and shaped to fit over the guide ramps 1754 or be aligned with the guide ramps 1754 when the chuck collar 1716 is in the unlocked configuration. In contrast, when the chuck collar 1716 rotates to the locked configuration, the guide ramps 1754 can slidably pass the notches 1766 and engage with the bevels 1764 (e.g., to maintain the engagement between the plate 1720 and the chuck collar 1716). As best shown in FIG. 19, the bevels 1764 circumferentially alternate with the notches 1766. Further, the notches 1766 are axially aligned with the channels 1762.

As mentioned above, the chuck collar 1716 can be retained in the unlocked configuration when the bit 1704 is removed from the chuck collar 1716. For example, as shown in FIG. 21, the ball bearings 1728 are positioned within the sockets 1718 as the bit 1704 moves past the ball bearings 1728 and float radially within the chuck collar 1716. The chuck collar 1716 remains engaged with the plate 1720 as the secondary spring 1730 biases the plate 1720 toward the chuck collar 1716. In particular, the notches 1766 engage with the guide ramps 1754, and the bevels 1764 are axially aligned with the sockets 1718. Accordingly, the chuck collar 1716 can be maintained in the unlocked configuration.

When the bit 1704 is inserted into the chuck collar 1716, the bit 1704 can engage with the chuck collar 1716 to cause the chuck collar 1716 to move into the locked configuration, automatically securing the bit 1704 in the chuck collar 1716. Specifically, when the bit 1704 moves the ball bearings 1728 (e.g., when the ball bearings 1728 contact a distal end of the corresponding slots 1710 as shown in FIG. 22), the ball bearings 1728 can be pushed out of the sockets 1718 and radially move toward the intermediate wall 1752. Accordingly, the ball bearings 1728 can push the plate 1720 in a rearward direction (e.g., toward the anvil 1702), and the secondary spring 1730 can be compressed. After the bit 1704 moves past the ball bearings 1728, the compressed secondary spring 1730 can expand, and the plate 1720 can be disengaged from the chuck collar 1716. The spring 1712, which is wound in the unlocked configuration) can expand, and the chuck collar 1716 can rotate back from the unlocked configuration to the locked configuration. Further, the secondary spring 1730 can expand, and the plate 1720 can move back in a forward direction (e.g., toward the ring 1742). With the chuck collar 1716 rotated to the locked configuration, the bevels 1764 are no longer axially aligned with the sockets 1718 but instead engage with the guide ramps 1754. Thus, the bit 1704 can be secured within the guide channel 1706A without (directly or manually) controlling the chuck collar 1716 at the same time.

When the chuck collar 1716 is in the locked configuration as shown in FIG. 20, the ball bearings 1728 are aligned with the inner wall 1717 and protrude at least partially into the guide channel 1706A. The chuck collar 1716 can internally block the forward movement of the plate 1720 caused by the secondary spring 1730. Accordingly, the tool holder 1700 can secure the bit 1704 when inserted into the anvil 1702, or the ball bearings 1728 at least partially within the guide channel 1706A can interfere with the bit 1704 to be inserted into the anvil 1702.

To remove the bit 1704 from the tool holder 1700, the chuck collar 1716 can be twisted in a counterclockwise direction (e.g., a first rotational direction, as shown in FIG. 18) to achieve the unlocked configuration of the chuck collar 1716. In the unlocked configuration, the spring 1712 is compressed between the chuck collar 1716 and the sleeve 1740. Further, various geometry of the chuck collar 1716 can align with the ball bearings 1728 to move the ball bearings 1728 radially outward (e.g., away from the axis 1734) as the bit 1704 comes in contact with the ball bearings 1728 during removal of the bit 1704. For example, the sockets 1718 can be aligned with the ball bearings 1728, which can be pushed into the sockets 1718 as the bit 1704 translates out of the guide channel 1706A as shown in FIG. 21. In some cases, the chuck collar 1716 can translate backward (e.g., toward the anvil 1702) as the removal force for the bit 1704 pushes the ball bearings 1728 to fit within the sockets 1718. Thus, the guide channel 1706A can include a clear pathway for the bit 1704 to be removed from the tool holder 1700.

In some cases, the expansion force from the spring 1712 and the secondary spring 1730 can bias the chuck collar 1716 to translate forward (e.g., toward the ring 1742). The plate 1720 and the chuck collar 1716 can remain engaged, and the chuck collar 1716 can remain in the unlocked configuration (e.g., until the bit 1704 is inserted). In some cases, the bit 1704 can be removed from the tool holder 1700 without (directly or manually) controlling the chuck collar 1716 at the same time.

In the present example, the tool holder 1700 includes four sets of the ball bearings 1728, the sockets 1718, the slots 1710, the bevels 1764 to collectively allow the tool holder 1700 to be moved between and secure in the locked and unlocked configurations. In some embodiments, more or fewer numbers of the sets can be provided (e.g., one set, two sets, three sets, five sets, six sets, etc.), or other types of detent mechanism (e.g., spring-operated retention members) can be used.

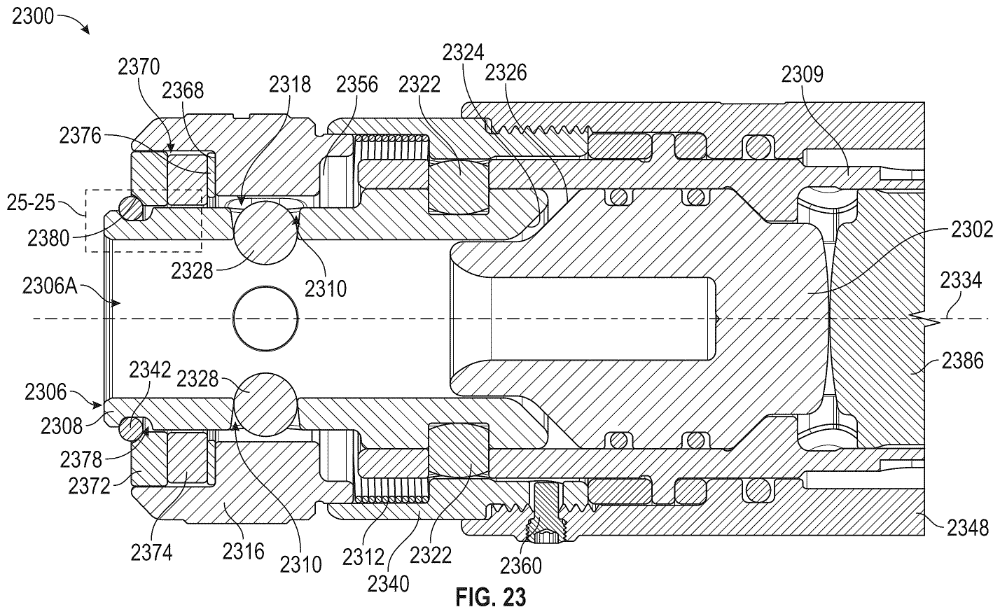

FIGS. 23-25 illustrate another example tool holder 2300, according to aspects of the disclosure, which can be implemented with, for example, the power tool 10 or on various other impact tools. Generally, the tool holder 2300 can include similar components and functions to the tool holder 1700. Thus, like names to designate the same or similar components described above will be used where applicable, and discussion of these components above generally applies relative to the examples below.

For example, the tool holder 2300 has a spindle 2306 (e.g., a front spindle, a shaft, a barrel, etc.) that includes a retainer 2308 (e.g., a front spindle) and a rear spindle 2309 that is coupled to the retainer 2308 via pins 2322, just as the spindle 1706 includes the retainer 1708 and the rear spindle 1709 that is coupled to the retainer 1708 via the pins 1722. The retainer 2308 defines a rear impact surface 2324, and the tool holder 2300 includes an anvil 2302 that defines a front anvil impact surface 2326. Further, the tool holder 2300 includes a chuck collar 2316 that moves relative to a ring 2342 that, which is secured to a distal end of the retainer 2308, and a sleeve 2340 (e.g., a front cap of a gearcase) of the tool holder 2300. The chuck collar 2316 is rotatable about an axis 2334 that extends between a front end of the tool holder 2300 and a rear end of the tool holder 2300, as shown in FIG. 23. The chuck collar 2316 is configured to engage a spring 2312 (e.g., a torsion spring) that biases a rotational movement of the chuck collar 2316 about the axis 2334 to a first rotational position (e.g., the locked configuration). The sleeve 2340 is threadably secured to a housing 2348 of a power tool for the tool holder 2300 via a fastener 2360.

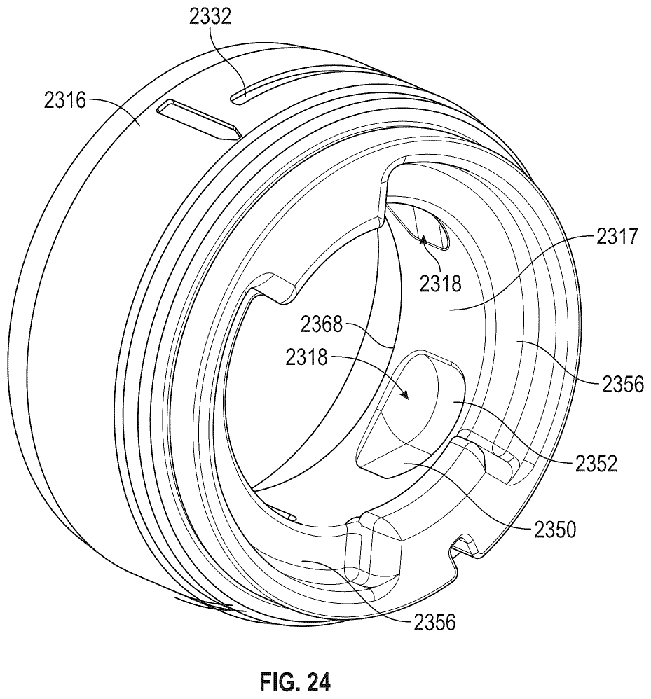

Referring to FIGS. 23 and 24, the chuck collar 2316 includes a variety of geometries that are sized and shaped to engage with ball bearings 2328 (or other retention members) that can be used to control opening and closing (e.g., blocking and unlocking) of a pathway of a bit along a guide channel 2306A defined by the retainer 2308. In the locked configuration (e.g., as shown in FIG. 23), the ball bearings 2328 protrude into the guide channel 2306A in slots 2310 of the retainer 2308. The slots 2310 are generally frustoconical shaped and narrow (e.g., taper) toward the guide channel 2306A. In the unlocked configuration, the ball bearings 2328 can move so that they do not protrude into the guide channel 2306A and are received into the chuck collar 2316. Accordingly, the bit can be removed from the guide channel 2306A or the anvil 2302 in the unlocked configuration.

As best shown in FIG. 24, the chuck collar 2316 includes an inner wall 2317 that includes sockets 2318 that are circumferentially spaced apart. The sockets 2318 are sized and shaped to receive the ball bearings 2328. The sockets 2318 include a ramped surface 2350 that extend from a curved surface 2352 (e.g., a semi-circular surface) of the sockets 2318 to the inner wall 2317. Accordingly, when a user twists the chuck collar 2316 to move the chuck collar 2316 in a clockwise direction along an arrow 2332 (e.g., to achieve the unlocked configuration), the ball bearings 2328 can gradually move along from the inner wall 2317 to the ramped surface 2350 and subsequently to the curved surface 2352. The sockets 2318 can be aligned with the slots 2310 in the unlocked configuration. Further, the inner wall 2317 includes ledges 2356 (e.g., a raised platform) extending axially from the inner wall 2317. When the chuck collar 2316 is rotated to achieve the locked configuration, the ledges 2356 can engage with the spindle 2306 and prevent over-rotation of the chuck collar 2316.

Further, the chuck collar 2316 includes a shelf 2368 that delimits a cavity 2370 between the chuck collar 2316 and the retainer 2308. The cavity 2370 is configured to receive various components that can help to retain the chuck collar 2316 on the power tool. As shown in FIG. 23, the cavity 2370 can receive a plate 2372, a bumper 2374 (e.g., a force absorbing member, a resilient member, etc.), and a disk 2376 (e.g., a washer, a plate, etc.). The plate 2372 includes a grooved surface 2380 that is configured to engage with a ring 2342 (e.g., a C-ring, an O-ring, a washer, etc.). In the illustrated example, the ring 2342 is secured to a distal end of the retainer 2308, so that the ring 2342 can maintain the position of the retainer 2308 relative to other components of the tool holder 2300. For example, the retainer 2308 includes a groove 2378 (e.g., an annular groove) that receives the ring 2342. The plate 2372 can include a grooved surface 2380 that is configured to engage with the groove 2378 when the plate 2372 is received within the chuck collar 2316. A profile of the grooved surface 2380 can generally correspond to a profile of the ring 2342.

With continued reference to FIGS. 23 and 24, various components of the tool holder 2300 can absorb an impact force exerted by a striker 2386 onto the anvil 2302 (e.g., along the axis 2334) when the anvil 2302 contacts the retainer 2308 or the rear spindle 2309 directly or indirectly (e.g., via the pins 2322). For example, repeated impacts by the striker 2386 to the anvil 2302 can cause the retainer 2308 to move toward the front of the tool holder 2300 when the front anvil impact surface 2326 repeatedly impacts the rear impact surface 2324. The forward movement of the retainer 2308 can cause a forward movement of the rear spindle 2309 that is coupled to the retainer 2308 via the pins 2322 (e.g., due to the clearance(s) between the pins 2322 and the rear spindle 2309 or the retainer 2308). Accordingly, the rear spindle 2309 can contact a rear end of the chuck collar 2316, and the chuck collar 2316 can bias the plate 2372, the bumper 2374, and the disk 2376 that are received in the cavity 2370 in a direction toward the front of the tool holder 2300. In some examples, the bumper 2374 can dampen the transferred impact force from the striker 2386, so that the transferred impact force is further transferred to the ring 2342 at a reduced magnitude. Accordingly, the ring 2342 can maintain the chuck collar 2316 on the power tool.

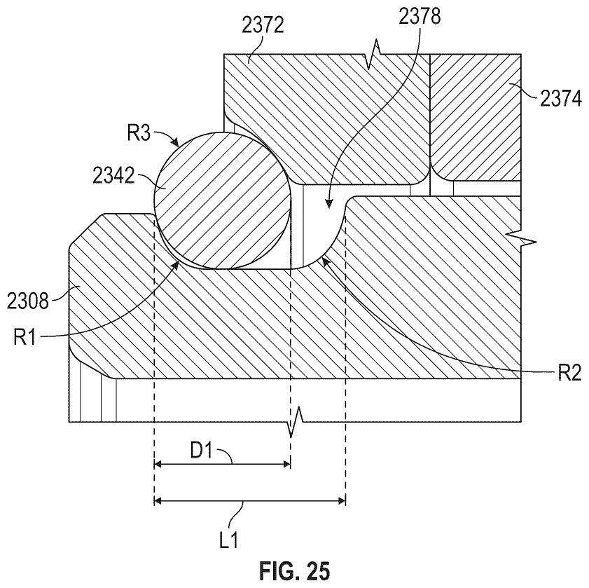

In some examples, the groove 2378 can be configured to reduce the magnitude of the impact force that is directly transferred to the ring 2342. As best shown in FIG. 25, the ring 2342 can move along the groove 2378, which has an axial length LI that is greater than a diameter DI of the ring 2342 (e.g. a cross-sectional diameter or depth). Accordingly, a clearance between the ring 2342 and the groove 2378 can allow the ring 2342 to translate within the groove 2378, and the retainer 2308 may not directly impact the ring 2342 during operation of the power tool.

With continued reference to FIG. 25, the configuration of the groove 2378 can further help to retain the ring 2342 within the groove 2378 when the striker 2386 repeatedly impacts the anvil 2302. In particular, the groove 2378 includes a front radius R1 (e.g., a first radius, a groove radius) at a distal end of the groove 2378 (e.g., toward the front of the tool holder 2300) and a rear radius R2 at a proximal end of the groove 2378 (e.g., toward the anvil 2302). The front radius R1 is smaller than the rear radius R2. The front radius R1 is smaller than a radius R3 (e.g., a second radius) of the ring 2342. Accordingly, when the impact force exerted by the striker 2386 is directly or indirectly (e.g., via the plate 2372) is applied to the ring 2342, the front radius R1 that is smaller than the radius R3 can prevent the ring 2342 from riding up and out of the groove 2378 or being stretched. For example, the front radius R1 can be between about 30% and about 95% of the radius R3, or between about 50% and about 85% of the radius R3. While the illustrated example includes the front radius R1 that is smaller than the rear radius R2, other examples can include the front radius R1 that is same as or greater than the rear radius R2.

In some implementations, devices or systems disclosed herein can be utilized, manufactured, or installed using methods embodying aspects of the invention. Correspondingly, any description herein of particular features, capabilities, or intended purposes of a device or system is generally intended to include disclosure of a method of using such devices for the intended purposes, a method of otherwise implementing such capabilities, a method of manufacturing relevant components of such a device or system (or the device or system as a whole), and a method of installing disclosed (or otherwise known) components to support such purposes or capabilities. Similarly, unless otherwise indicated or limited, discussion herein of any method of manufacturing or using for a particular device or system, including installing the device or system, is intended to inherently include disclosure, as embodiments of the invention, of the utilized features and implemented capabilities of such device or system.

Also as used herein, unless otherwise limited or defined, “or” indicates a non-exclusive list of components or operations that can be present in any variety of combinations, rather than an exclusive list of components that can be present only as alternatives to each other. For example, a list of “A, B, or C” indicates options of: A; B; C; A and B; A and C; B and C; and A, B, and C. Correspondingly, the term “or” as used herein is intended to indicate exclusive alternatives only when preceded by terms of exclusivity, such as “either,” “one of,” “only one of,” or “exactly one of.” For example, a list of “one of A, B, or C” indicates options of: A, but not B and C; B, but not A and C; and C, but not A and B. A list preceded by “one or more” (and variations thereon) and including “or” to separate listed elements indicates options of one or more of any or all of the listed elements. For example, the phrases “one or more of A, B, or C” and “at least one of A, B, or C” indicate options of: one or more A; one or more B; one or more C; one or more A and one or more B; one or more B and one or more C; one or more A and one or more C; and one or more of A, one or more of B, and one or more of C. Similarly, a list preceded by “a plurality of” (and variations thereon) and including “or” to separate listed elements indicates options of multiple instances of any or all of the listed elements. For example, the phrases “a plurality of A, B, or C” and “two or more of A, B, or C” indicate options of: A and B; B and C; A and C; and A, B, and C.

Also as used herein, unless otherwise defined or limited, directional terms are used for convenience of reference for discussion of particular figures or examples or to indicate spatial relationships relative to particular other components or context, but are not intended to indicate absolute orientation. For example, references to downward, forward, or other directions, or to top, rear, or other positions (or features) may be used to discuss aspects of a particular example or figure, but do not necessarily require similar orientation or geometry in all installations or configurations.

Additionally, unless otherwise specified or limited, “substantially coaxial” indicates that the described elements have axes that are substantially parallel with each other and are aligned so that extension of the axis of one of the elements intersects an axial end of another of the elements (e.g., at or within a diameter or other maximum width thereof, within 50% of a diameter or other maximum width thereof, within 25% of a diameter or other maximum width thereof, or within 5%—or less—of a diameter or other maximum width thereof).

Also as used herein, unless otherwise limited or defined, “integral” and derivatives thereof (e.g., “integrally”) describe elements that are manufactured as a single piece without fasteners, adhesive, or the like to secure separate components together. For example, an element stamped, cast, or otherwise molded as a single-piece component from a single piece of sheet metal or using a single mold, without rivets, screws, or adhesive to hold separately formed pieces together is an integral (and integrally formed) element. In contrast, an element formed from multiple pieces that are separately formed initially then later connected together, is not an integral (or integrally formed) element.

Additionally, unless otherwise specified or limited, the terms “about” and “approximately,” as used herein with respect to a reference value, refer to variations from the reference value of ±15% or less, inclusive of the endpoints of the range. Similarly, the term “substantially equal” (and the like) as used herein with respect to a reference value refers to variations from the reference value of less than ±10%, inclusive. Where specified, “substantially” can indicate in particular a variation in one numerical direction relative to a reference value. For example, “substantially less” than a reference value (and the like) indicates a value that is reduced from the reference value by 10% or more, and “substantially more” than a reference value (and the like) indicates a value that is increased from the reference value by 10% or more.

Also as used herein, unless otherwise limited or specified, “substantially identical” refers to two or more components or systems that are manufactured or used according to the same process and specification, with variation between the components or systems that are within the limitations of acceptable tolerances for the relevant process and specification. For example, two components can be considered to be substantially identical if the components are manufactured according to the same standardized manufacturing steps, with the same materials, and within the same acceptable dimensional tolerances (e.g., as specified for a particular process or product).

Unless otherwise specifically indicated, ordinal numbers are used herein for convenience of reference, based generally on the order in which particular components are presented in the relevant part of the disclosure. In this regard, for example, designations such as “first,” “second,” etc., generally indicate only the order in which a thus-labeled component is introduced for discussion and generally do not indicate or require a particular spatial, functional, temporal, or structural primacy or order.

The previous description of the disclosed embodiments is provided to enable any person skilled in the art to make or use the invention. Given the benefit of this disclosure, various modifications to these embodiments will be readily apparent to those skilled in the art, and the principles defined herein may be applied to other embodiments without departing from the spirit or scope of the invention. Thus, the invention is not intended to be limited to the embodiments shown herein but is to be accorded the widest scope consistent with the principles and novel features disclosed herein.

What is claimed is:

1. A tool holder for a rotary impact tool, the tool holder comprising:
a spindle defining a longitudinal axis, the spindle including a channel extending along the longitudinal axis, and a plurality of slots that open into the channel; and
an anvil movably received in the spindle and configured to impact a bit;
a plurality of retention members received in the plurality of slots; and
a chuck collar that is rotatable about the longitudinal axis between an unlocked configuration and a locked configuration, the chuck collar including a plurality of sockets configured to receive the plurality of retention members, the plurality of retention members being recessed in the plurality of sockets in the unlocked configuration and extending through the plurality of slots into the channel in the locked configuration.

2. The tool holder of claim 1 further comprising a retaining ring that is coupled to the spindle retain the chuck collar on the spindle.

3. The tool holder of claim 2 further comprising resilient member positioned between the retaining ring and the chuck collar.

4. The tool holder of claim 3, wherein the spindle includes a first spindle that is configured to retain the anvil, and a second spindle that is coupled to and coaxial with the first spindle, the first spindle including a groove that receives the retaining ring.

5. The tool holder of claim 4, wherein the groove defines an axial length taken along the longitudinal axis, and the retaining ring defines a depth taken along the longitudinal axis, which is smaller than the axial length of the groove.

6. The tool holder of claim 4, wherein the groove defines a first radius at a bottom of the groove, and
wherein the retaining ring has a circular cross section with a second radius that is greater than the first radius.

7. The tool holder of claim 6, wherein the first radius is between about 30% and about 95% of the second radius.

8. The tool holder of claim 1 further comprising a sleeve that covers at least a portion of the chuck collar, the sleeve is threadably secured to a housing of the rotary impact tool.

9. The tool holder of claim 8, wherein the sleeve is secured to the housing via a fastener.

10. The tool holder of claim 1 further comprising a biasing member that engages with the chuck collar to bias the chuck collar to the locked configuration.

11. The tool holder of claim 1, wherein an area of each of the plurality of slots narrows so that the area is greater along an external surface of the spindle than along an inner surface of the spindle that bounds the channel.

12. The tool holder of claim 1, wherein the chuck collar includes an inner wall that includes the plurality of sockets, and
wherein each of the plurality of sockets includes a ramped surface that extends between a bottom of the socket and the inner wall.

13. The tool holder of claim 1, wherein the chuck collar includes a ledge that engages with the spindle to limit rotation of the chuck collar.

14. A tool holder for a power tool, the tool holder comprising:
a spindle that defines a channel that is configured to receive a bit along a longitudinal axis of the power tool, the spindle including a slot that is configured to receive a retention member and a first groove at a distal end of the spindle;
a chuck collar that is co-axially aligned with the spindle, the chuck collar including a socket that is configured to receive the retention member, the chuck collar being rotatable relative to the spindle to selectively align the socket with the slot to allow removal of the bit from the channel; and
a retaining ring received in the first groove and configured to limit a translation of the chuck collar past the retaining ring in a direction toward the distal end of the spindle.

15. The tool holder of claim 14, wherein the first groove includes an axial length that is greater than a cross-sectional diameter of the retaining ring.

16. The tool holder of claim 14, wherein a radius of the first groove is smaller than a cross-sectional radius of the retaining ring.

17. The tool holder of claim 14, further comprising:
a resilient member between the chuck collar and the retaining ring;
a first plate positioned between the resilient member and the retaining ring, the first plate including a second groove that receives the retaining ring; and
a second plate positioned between the resilient member and the chuck collar.

18. A power tool comprising:
a housing;
a motor disposed in the housing;
a first spindle coupled to the housing and defining a longitudinal axis,
a second spindle coupled to the first spindle with a fastener, the second spindle including a channel surrounded by a peripheral wall and a slot that extends through the peripheral wall;
retention member received in the slot;
a chuck collar that is rotatable about the longitudinal axis between an unlocked configuration where a socket defined in an inner surface of the chuck collar is aligned with the slot to receive the retention member, and a locked configuration where the socket is out of alignment with the slot;
a reciprocation assembly driven by the motor and including a striker movably received in the first spindle;
an anvil movably received in the first spindle, the anvil moving toward the second spindle when the striker contacts the anvil;
a retainer positioned in a groove defined in an external surface of the second spindle; and
a resilient member positioned between the retainer and the chuck collar.

19. The power tool of claim 18, wherein the striker contacting the anvil causes the anvil to contact the second spindle and move the second spindle along the longitudinal axis from a first position toward a second position relative to the first spindle, the movement of the second spindle limited by the fastener; and
wherein a distance between the first position and the second position is less than a length of the groove taken along the longitudinal axis.

20. The power tool of claim 19, wherein the first spindle moves with the second spindle when the second spindle reaches the second position, the first spindle contacting the chuck collar and causing the chuck collar to move toward the resilient member, the resilient member compressing between the chuck collar and the retainer to absorb force imparted to the chuck collar by the first spindle.
